(19) United States
(12) Patent Application Publication
(10) Pub. No.: US 2017/0353226 A1
(43) Pub. Date: Dec. 7, 2017

(54) DYNAMIC CHAIN CONFIGURATION SELECTION

(71) Applicant: QUALCOMM Incorporated, San Diego, CA (US)

(72) Inventors: Sandip HomChaudhuri, San Jose, CA (US); Pradeep Kumar Yenganti, Cupertino, CA (US); Srikant Kuppa, Fremont, CA (US); Zhanfeng Jia, Belmont, CA (US); Ning Zhang, Saratoga, CA (US); Ravi Gidvani, Fremont, CA (US); Subramania Sharma Thandaveswaran, Milpitas, CA (US); Ravi Konda, San Jose, CA (US)

(21) Appl. No.: 15/611,353

(22) Filed: Jun. 1, 2017

Related U.S. Application Data
(60) Provisional application No. 62/344,755, filed on Jun. 2, 2016.

(51) Int. Cl. H04B 7/06; H04B 17/318; H04L 12/26; H04W 84/12

(52) U.S. Cl. CPC H04B 7/0691; H04L 43/16; H04B 17/318; H04B 7/0697; H04W 84/12

(57) ABSTRACT

Methods, systems, and devices for wireless communication are described. A wireless device (e.g., an access point or a station) capable of supporting multiple chain configuration modes may monitor traffic on a wireless channel. The wireless device may, based on the monitoring, determine a series of values for a metric that is indicative of communication conditions. The metric may be a packet rate, channel congestion, or signal strength. The wireless device may dynamically select one of the supported chain configuration modes in which to operate based on the series of values for the metric. In some cases, the wireless device may compute a value for the metric based on the series of values and compare the value of the metric to a predetermined threshold. In such cases, selection of the chain configuration mode may be based on the results of the comparison. In some examples, one or metrics may be used.

### CROSS REFERENCES

The present Application for Patent claims priority to U.S. Provisional Patent Application No. 62/344,755 by HomChaudhuri, et al., entitled “Dynamic Chain Configuration Selection,” filed Jun. 2, 2016, assigned to the assignee hereof, and expressly incorporated by reference herein.

### BACKGROUND

The following relates generally to wireless communications, and more specifically to dynamic chain configuration selection.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (e.g., IEEE 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. The downlink (or forward link) may refer to the communication link from the AP to the station, and the uplink (or reverse link) may refer to the communication link from the station to the AP.

A STA may communicate with an AP according to a number of different chain configuration modes, including modes that use multiple antennas or a single antenna. The power consumption and energy efficiency of each chain configuration mode may vary depending on the communication conditions. For example, a chain configuration mode that uses a single antenna may be more efficient than a chain configuration mode that uses multiple antennas in some circumstances, while a chain configuration mode that uses multiple antennas may be more efficient than a chain configuration mode that uses a single antenna in some circumstances. A STA that uses a constant chain configuration during transmission and/or reception may fail to use energy-efficient chain configuration modes in light of prevailing communication conditions, and thus may use excess energy and waste power.

### SUMMARY

The described features generally relate to one or more improved systems, methods, and/or apparatuses for dynamic chain configuration mode selection in wireless devices. More specifically, the described features generally relate to selectively operating a wireless device (e.g., a station (STA) or an access point (AP)) in different chain configuration modes based on monitored traffic on a wireless channel. The STA may gather information about the communication conditions of a wireless channel by monitoring traffic over the wireless channel and determine a series of values for the traffic. The STA may gather values related to one or more metrics associated with the traffic. For example, the STA may analyze aspects of packets it receives and/or transmits, or energy on the wireless channel, to determine metrics the STA can use to determine which chain configuration mode to use. The STA may analyze aspects of packets received from an AP, or from third-party wireless devices. The metrics considered by the STA may include packet rate, channel congestion, signal strength, and signal strength across different chains of a chain configuration mode. The STA may compare one or more of these metrics to a corresponding threshold value, the result of which may be used by the STA to determine a chain configuration mode in which the STA will operate. Accordingly, the STA may dynamically switch chain configuration modes.

An apparatus for wireless communications is described. The apparatus may include a memory that stores instructions and a processor coupled with the memory. The processor and memory may be configured to monitor traffic on a wireless channel and determine a series of values for a first metric associated with the monitored traffic. The processor and memory may be configured to switch from operating the apparatus in a first chain configuration mode to operating the apparatus in a second chain configuration mode to communicate on the wireless channel based at least in part on the determined series of values for the first metric.

A method of wireless communications at a wireless device is described. The method may include monitoring, by the wireless device, traffic on a wireless channel and determining a series of values for a first metric associated with the monitored traffic. The method may include switching from operating the wireless device in a first chain configuration mode to operating the wireless device in a second chain configuration mode to communicate on the wireless channel based at least in part on the determined series of values for the first metric.

A further apparatus for wireless communications is described. The apparatus may include means for monitoring traffic on a wireless channel, and means for determining a series of values for a first metric associated with the monitored traffic. The apparatus may include means for switching from operating the apparatus in a first chain configuration mode to operating the apparatus in a second chain configuration mode to communicate on the wireless channel based at least in part on the determined series of values for the first metric.

A non-transitory computer readable medium for wireless communications is described. The non-transitory computer-readable medium may store code comprising instructions executable to monitor traffic on a wireless channel and determine a series of values for a first metric associated with the monitored traffic. The non-transitory computer-readable medium may store code comprising instructions executable to switch from operating the wireless device in a first chain configuration mode to operating the wireless device in a second chain configuration mode to communicate on the wireless channel based at least in part on the determined series of values for the first metric.

In some examples of the method, apparatus, or non-transitory computer-readable medium described above, the first metric is at least one of a signal-to-noise ratio (SNR), a received signal strength indicator (RSSI), a packet rate, a channel congestion, or a difference between RSSI across chains of the first chain configuration mode, or a combination thereof

Some examples of the method, apparatus, or non-transitory computer-readable medium described above may further include processes, features, means, or instructions for calculating a first value for the first metric based at least in part on the series of values. Some examples of the method, apparatus, or non-transitory computer-readable medium described above may further include processes, features, means, or instructions for comparing the first value for the first metric to a first predetermined threshold, wherein switching from operating the apparatus in the first chain configuration mode to operating the apparatus in the second chain configuration mode is based at least in part on a result of the comparison. Some examples of the method, apparatus, or non-transitory computer-readable medium described above may further include processes, features, means, or instructions for calculating a second value for a second metric and comparing the second value for the second metric to a second predetermined threshold. Some examples of the method, apparatus, or non-transitory computer-readable medium described above may further include processes, features, means, or instructions for switching from operating the apparatus in the second chain configuration mode to operating the apparatus in the first chain configuration mode based at least in part on the comparison of the second value for the second metric to the second predetermined threshold. The first predetermined threshold may be equal to the second predetermined threshold.

In some examples of the method, apparatus, or non-transitory computer-readable medium described above, the first value is an average packet. In some examples of the method, apparatus, or non-transitory computer-readable medium described above, selectively operating includes switching from operating in the first chain configuration mode to operating in the second chain configuration mode if the average packet rate exceeds the first predetermined threshold and switching from operating in the second chain configuration mode to operating in the first chain configuration mode if the average packet rate falls below a second predetermined threshold.

In some examples of the method, apparatus, or non-transitory computer-readable medium described above, calculating the first value includes determining a moving average for the first metric during a first time period based at least in part on one or more values of the series of values. In some examples of the method, apparatus, or non-transitory computer-readable medium described above, the first metric is a signal strength. Some examples of the method, apparatus, or non-transitory computer-readable medium described above may further include processes, features, means, or instructions for monitoring the traffic comprises determining the signal strength of a received packet based at least in part on a preamble of the received packet. In some examples of the method, apparatus, or non-transitory computer-readable medium described above, switching from operating the apparatus in the first chain configuration mode to operating the apparatus in the second chain configuration mode includes identifying that the signal strength is less than a predetermined threshold and enabling at least one additional chain based at least in part on the identification.

Some examples of the method, apparatus, or non-transitory computer-readable medium described above may further include processes, features, means, or instructions for determining that a signal strength difference between chains is greater than a first predetermined threshold and turning off one or more of the chains operated in the first chain configuration mode with a signal strength below a second predetermined threshold based at least in part on the signal strength difference. In some examples, determining that the signal strength difference is greater than the predetermined threshold includes determining a standard deviation of signal strength across chains operated in the first chain configuration mode is greater that the first predetermined threshold.

In some examples of the method, apparatus, or non-transitory computer-readable medium described above, the first metric is a channel congestion. In some examples of the method, apparatus, or non-transitory computer-readable medium described above, monitoring traffic includes detecting energy from other wireless devices on the wireless channel. Some examples of the method, apparatus, or non-transitory computer-readable medium described above may further include processes, features, means, or instructions for determining a second series of values for a second metric associated with the monitored traffic, wherein switching from operating the apparatus in the first chain configuration mode to operating the apparatus in the second chain configuration mode is based at least in part on the determined series of values for the first metric and the determined series of values for the second metric.

In some examples of the method, apparatus, or non-transitory computer-readable medium described above, the first metric is a packet rate and the second metric is a channel congestion. Some examples of the method, apparatus, or non-transitory computer-readable medium described above may further include processes, features, means, or instructions for determining that the packet rate is less than a first predetermined threshold and the channel congestion is less than a second predetermined threshold. In some examples, switching from operating the apparatus in the first chain configuration mode to operating the apparatus in the second chain configuration mode is based at least in part on a packet rate value and a channel congestion value. Some examples of the method, apparatus, or non-transitory computer-readable medium described above may further include processes, features, means, or instructions for determining that the packet rate is greater than a first predetermined threshold or the channel congestion is greater than a second predetermined threshold. Some examples of the method, apparatus, or non-transitory computer-readable medium described above may further include processes, features, means, or instructions for switching from operating the apparatus in the first chain configuration mode to operating the apparatus in the second chain configuration mode based at least in part on the determination that the packet rate is greater than a first predetermined threshold or the channel congestion is greater than a second predetermined threshold, wherein the second chain configuration mode comprises a maximum number of chains supported by the wireless device.

In some examples of the method, apparatus, or non-transitory computer-readable medium described above, the first chain configuration mode comprises a single chain and the second chain configuration mode comprises a plurality of chains. In some examples, switching from operating the apparatus in the first chain configuration mode to operating the apparatus in the second chain configuration mode includes selecting to operate in the first chain configuration mode to listen for a control transmission on the wireless channel and selecting to operate in the second chain configuration mode to communicate on the wireless channel based at least in part on the control transmission. In some cases, the control transmission is a request-to-send (RTS) message or a clear-to-send (CTS) message. Some examples of the method, apparatus, or non-transitory computer-readable medium described above may further include processes, features, means, or instructions for transmitting an indication of at least one of the first chain configuration mode, the second chain configuration mode, or a combination thereof, to an AP, wherein the indication comprises a spatial multiplexing power save (SMPS) action frame.

In some examples of the method, apparatus, or non-transitory computer-readable medium described above switching from operating the wireless device in the first chain configuration mode to operating the wireless device in the second chain configuration mode includes determining to switch from operating the wireless device in the first chain configuration mode to operating the wireless device in the second chain configuration mode to communicate on the wireless channel based at least in part on the determined series of values for the first metric, determining to operate in a SMPS mode based at least in part on the determination to switch, and switching from operating the wireless device in the first chain configuration mode to operating the wireless device in the second chain configuration mode after determining to operate in the SMPS mode.

In some examples, the first chain configuration mode corresponds to at least one of a single-input-single-output (SISO) mode, a multiple-input-multiple-output (MIMO) mode, single-input-multiple-output (SIMO) mode, or a multiple-input-single-output (MISO) mode and the second chain configuration mode corresponds to at least one of a SISO mode, a MIMO mode, SIMO mode, or a MISO mode. The first chain configuration mode may be different from the second chain configuration mode. In some examples, the apparatus is a wireless communication terminal and further comprises an antenna and a transceiver. Some examples of the method, apparatus, or non-transitory computer-readable medium described above may further include processes, features, means, or instructions for transmitting an indication of at least one of the first chain configuration mode, the second chain configuration mode, or a combination thereof, to an AP, wherein the indication is embedded in a data frame. In some examples of the method, apparatus, or non-transitory computer-readable medium described above, the first metric comprises at least one of a physical layer convergence protocol (PLCP) protocol data unit (PPDU) packet rate, an aggregated medium access control (MAC) protocol data unit (A-MPDU) packet rate, or an aggregated MAC service data unit (A-MSDU) packet rate, or a combination thereof.

In some examples, operating in the first chain configuration mode may include listening for a control transmission on the wireless channel using a first chain configuration of the first chain configuration mode, and communicating, based at least in part on the control transmission, on the wireless channel using a second chain configuration of the first chain configuration mode. Some examples of operating in the second chain configuration may include communicating on the wireless channel using a third chain configuration of the second chain configuration mode.

An apparatus for wireless communications operating according to a first chain configuration mode is described. The apparatus may include a memory that stores instructions and a processor coupled with the memory. The processor and memory may be configured to monitor traffic over a wireless channel, determine a RSSI difference across chains of the first chain configuration mode, an average RSSI, a packet rate, and a channel congestion for the wireless channel based at least in part on the monitoring, turn off chains of the first chain configuration mode if the RSSI difference is greater than a first predetermined threshold, enable one or more additional receive chains if the RSSI difference is less than the first predetermined threshold and the average RSSI is less than a second predetermined threshold, continue monitoring traffic over the wireless channel if the RSSI difference is less than the first predetermined threshold, the average RSSI is greater than the second predetermined threshold, and the average RSSI is less than a third predetermined threshold, select, based at least in part on a lookup table, a second chain configuration mode if the RSSI difference is less than the first predetermined threshold, the average RSSI is greater than both the second predetermined threshold and the third predetermined threshold, the packet rate is less than a fourth predetermined threshold, and the channel congestion is less than a fifth predetermined threshold, and switch to a third chain configuration mode that includes a maximum number of chains supported by the apparatus if the RSSI difference is less than the first predetermined threshold, the average RSSI is greater than both the second predetermined threshold and the third predetermined threshold, and the packet rate is greater than the fourth predetermined threshold, the channel congestion is greater than the fifth predetermined threshold, and the packet rate is greater than a sixth predetermined threshold or the channel congestion is less than a seventh predetermined threshold.

A method for wireless communications at a wireless device operating according to a first chain configuration mode is described. The method may include monitoring traffic over a wireless channel, determining a RSSI difference across chains of the first chain configuration mode, an average RSSI, a packet rate, and a channel congestion for the wireless channel based at least in part on the monitoring, turning off chains of the first chain configuration mode if the RSSI difference is greater than a first predetermined threshold, enabling one or more additional receive chains if the RSSI difference is less than the first predetermined threshold and the average RSSI is less than a second predetermined threshold, continuing to monitor traffic over the wireless channel if the RSSI difference is less than the first predetermined threshold, the average RSSI is greater than the second predetermined threshold, and the average RSSI is less than a third predetermined threshold, selecting, based at least in part on a lookup table, a second chain configuration mode if the RSSI difference is less than the first predetermined threshold, the average RSSI is greater than both the second predetermined threshold and the third predetermined threshold, the packet rate is less than a fourth predetermined threshold, and the channel congestion is less than a fifth predetermined threshold, and switching to a third chain configuration mode that includes a maximum number of chains supported by the apparatus if the RSSI difference is less than the first predetermined threshold, the average RSSI is greater than both the second predetermined threshold and the third predetermined threshold, and the packet rate is greater than the fourth predetermined threshold, the channel congestion is greater than the fifth predetermined threshold, and the packet rate is greater than a sixth predetermined threshold or the channel congestion is less than a seventh predetermined threshold.

A further apparatus for wireless communications is described. The apparatus may include means for monitoring traffic over a wireless channel, means for determining a RSSI difference across chains of the first chain configuration mode, an average RSSI, a packet rate, and a channel congestion for the wireless channel based at least in part on the monitoring, means for turning off chains of the first chain configuration mode if the RSSI difference is greater than a first predetermined threshold, means for enabling one or more additional receive chains if the RSSI difference is less than the first predetermined threshold and the average RSSI is less than a second predetermined threshold, means for continuing to monitor traffic over the wireless channel if the RSSI difference is less than the first predetermined threshold, the average RSSI is greater than the second predetermined threshold, and the average RSSI is less than a third predetermined threshold, means for selecting, based at least in part on a lookup table, a second chain configuration mode if the RSSI difference is less than the first predetermined threshold, the average RSSI is greater than both the second predetermined threshold and the third predetermined threshold, the packet rate is less than a fourth predetermined threshold, and the channel congestion is less than a fifth predetermined threshold, and means for switching to a third chain configuration mode that includes a maximum number of chains supported by the apparatus if the RSSI difference is less than the first predetermined threshold, the average RSSI is greater than both the second predetermined threshold and the third predetermined threshold, and the packet rate is greater than the fourth predetermined threshold, the channel congestion is greater than the fifth predetermined threshold, and the packet rate is greater than a sixth predetermined threshold or the channel congestion is less than a seventh predetermined threshold.

A non-transitory computer readable medium for wireless communications is described. The non-transitory computer-readable medium may store code comprising instructions executable to monitor traffic over a wireless channel, determine a RSSI difference across chains of the first chain configuration mode, an average RSSI, a packet rate, and a channel congestion for the wireless channel based at least in part on the monitoring, turn off chains of the first chain configuration mode if the RSSI difference is greater than a first predetermined threshold, enable one or more additional receive chains if the RSSI difference is less than the first predetermined threshold and the average RSSI is less than a second predetermined threshold, continue monitoring traffic over the wireless channel if the RSSI difference is less than the first predetermined threshold, the average RSSI is greater than the second predetermined threshold, and the average RSSI is less than a third predetermined threshold, select, based at least in part on a lookup table, a second chain configuration mode if the RSSI difference is less than the first predetermined threshold, the average RSSI is greater than both the second predetermined threshold and the third predetermined threshold, the packet rate is less than a fourth predetermined threshold, and the channel congestion is less than a fifth predetermined threshold, and switch to a third chain configuration mode that includes a maximum number of chains supported by the apparatus if the RSSI difference is less than the first predetermined threshold, the average RSSI is greater than both the second predetermined threshold and the third predetermined threshold, and the packet rate is greater than the fourth predetermined threshold, the channel congestion is greater than the fifth predetermined threshold, and the packet rate is greater than a sixth predetermined threshold or the channel congestion is less than a seventh predetermined threshold.

### BRIEF DESCRIPTION OF THE DRAWINGS

FIG. 1 illustrates a wireless communications system that supports dynamic chain configuration selection in accordance with aspects of the present disclosure.

FIG. 2 illustrates an example of a wireless communications system that supports dynamic chain configuration selection in accordance with aspects of the present disclosure.

FIG. 3 illustrates an example of dynamic chain configuration selection in accordance with aspects of the present disclosure.

FIG. 4 illustrates an example of a flow diagram that supports dynamic chain configuration selection in accordance with aspects of the present disclosure.

FIG. 5 illustrates an example of a transmission that supports dynamic chain configuration selection in accordance with aspects of the present disclosure.

FIG. 6 illustrates an example of a timing diagram that supports dynamic chain configuration selection in accordance with aspects of the present disclosure.

FIGS. 7 through 9 show block diagrams of a wireless device that supports dynamic chain configuration selection in accordance with aspects of the present disclosure.

FIG. 10 illustrates a block diagram of a system including a station that supports dynamic chain configuration selection in accordance with aspects of the present disclosure.

FIGS. 11 through 14 illustrate methods for dynamic chain configuration selection in accordance with aspects of the present disclosure.

### DETAILED DESCRIPTION

The described features generally relate to improved chain configuration selection for a wireless device (e.g., a station (STA) or an access point (AP)) of a wireless network by switching between chain configuration modes that the wireless device is operating in based on communication conditions. Though generally described herein with reference to a STA, the described features relating to improved chain configuration selection may be implemented by different wireless devices, for example a STA or an AP. A STA may detect certain communication conditions by monitoring traffic on a wireless channel, and switch its chain configuration mode accordingly. Power consumption and energy use by the chain configuration modes may vary with communication conditions. In an example featuring two chain configuration modes, one of the modes may be more energy efficient when the STA is operating in certain communication conditions (e.g., high throughput or high packet rate scenarios) while the other mode may be more energy efficient in other communication conditions (e.g., low throughput or low packet rate scenarios).

In some cases, a STA may support a chain configuration mode that uses multiple chains, which may be referred to as a multi-chain mode, to transmit or receive traffic on a channel. The STA may also support a chain configuration mode that uses a single chain, which may be referred to as a single-chain mode, for such communications. During receive operations, the multi-chain mode may receive packets faster and consume more power per unit time than the single-chain mode. The multi-chain mode and the single-chain mode may be energy efficient in different communication scenarios. For example, a STA may wait a period of time (referred to as an inactivity interval or listening interval) after the last packet of a received transmission before powering down, during which the STA may be listening for transmissions, and available to receive a packet or other communications. Alternatively, if a packet it not received during the inactivity interval, the STA may go into a low power mode after the inactivity interval.

In some cases, packets in a downlink transmission may be sent to a STA in rapid succession (e.g., at a high packet rate). In such cases, the STA may receive the transmission quickly by using the multi-chain mode. Due to the high packet rate, the inactivity intervals may be shorter, which means the STA can more quickly enter a low power mode, thereby saving energy. If instead the STA uses a single-chain mode to receive the packets, completion of the transmission may take longer, which may delay entrance into the low power mode and cost the STA energy. Thus, a multi-chain configuration mode may be energy efficient for high-throughput, or high packet rate, communications.

In other cases, packets in a downlink transmission may be sent to the STA in slow succession. In such cases, the STA may spend similar amounts of time in low power mode regardless of the chain configuration uses. But the STA may consume less power per unit time receiving the packets by using the single-chain mode instead of the multi-chain mode. Thus, a single-chain configuration mode may be energy efficient for low-throughput, or low packet rate, communications.

Thus, where a STA operates in a predetermined or static chain configuration mode, the chain configuration mode may be energy inefficient and waste power in some circumstances (e.g., channel conditions) in which the STA operates. As described further herein, a STA may monitor the traffic on a wireless channel to recognize when these conditions occur, and selectively switch its chain configuration mode to adapt, thereby reducing its overall power consumption and increase energy efficiency in view of changing channel conditions.

In some cases, the STA may recognize or determine the communication conditions in which it is operating by monitoring aspects of packets it receives or sends over a wireless channel. The STA may also determine the communication conditions of the wireless channel by monitoring energy on the wireless channel (e.g., from other wireless devices, such as Wi-Fi and/or non-Wi-Fi devices). By monitoring the energy on the wireless channel, the STA may determine channel congestion on the wireless channel. By monitoring the packets the STA sends and receives, the STA may determine metrics such as packet rate, received signal strength indicator (RSSI) and signal to noise ratio (SNR). The packet rate may be the packet rate of physical layer convergence protocol (PLCP) protocol data units (PPDUs), aggregated medium access control (MAC) protocol data unit (A-MPDUs), or aggregated MAC service data unit (A-MSDUs). The STA may consider these metrics when determining which chain configuration mode in which to operate.

In one example, the STA may determine the RSSI (e.g., the average RSSI) associated with chains in a chain configuration and determine whether to switch chain configuration modes based on the RSSI. For example, if the RSSI is less than a predetermined threshold RSSI, the STA may enable additional chains for receiving transmissions on the wireless channel. If the RSSI is greater than a predetermined threshold RSSI (which may be different than the predetermine threshold RSSI used in the previous determination), the STA may evaluate other conditions, such as packet rate and channel congestion, to determine its chain configuration mode. For example, the STA may determine that the packet rate and channel congestion are both less than respective corresponding thresholds, at which point the STA may reference a lookup table to determine which chain configuration to use given the values of the packet rate and channel congestion. Alternatively, the STA may determine that the packet rate and channel congestion are both greater than respective thresholds. In this situation, the STA may switch to operating in the chain configuration mode with the maximum number of chains supported by the STA, or may keep operating in the chain configuration mode with the maximum number of chains supported by the STA (e.g., if the STA is already operating in that mode).

In some cases, the STA may consider the RSSI difference across chains of its current chain configuration mode when determining whether to switch modes. For instance, if the RSSI difference between two chains is greater than a predetermined threshold, the STA may determine that one of the chains is not contributing to reception enough to justify its power consumption. Accordingly, the STA may turn off the chain with the lowest RSSI. If more than two chains are used in the STA's current chain configuration mode, the STA may determine the standard deviation of RSSI across the chains and, if the standard deviation satisfies a threshold, turn off one or more chains with the lowest RSSI. If the standard deviation does not satisfy the threshold, the STA may evaluate other metrics, such as channel congestion and packet rate, to select a chain configuration mode in which to operate.

The value for each of the metrics described herein may be calculated based on a series of values gathered by the STA while monitoring traffic on the wireless channel. The value may be updated by using the latest y values obtained from the monitoring. In some examples, the values of the metrics may be running averages.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

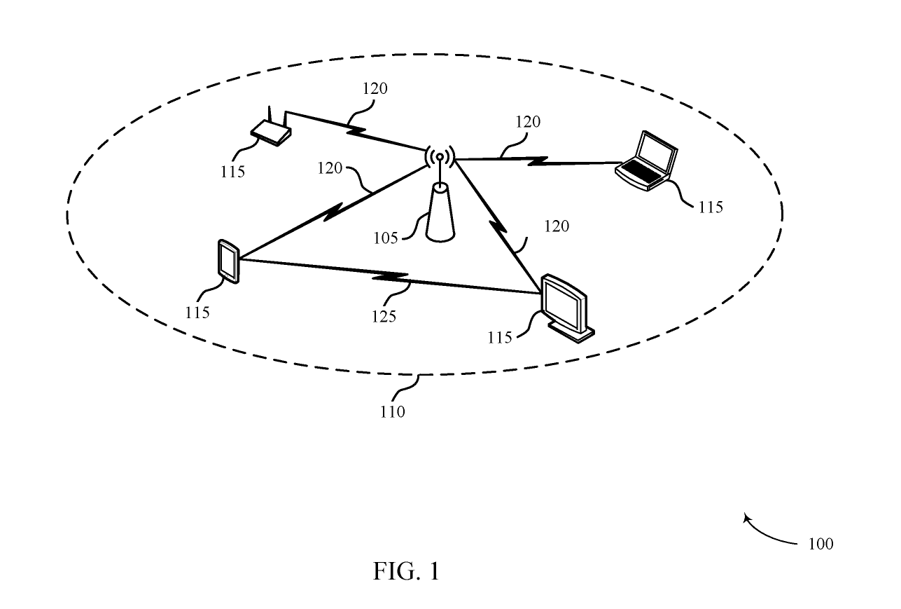

FIG. 1 illustrates a wireless communications system 100 configured in accordance with various aspects of the present disclosure. The wireless communications system 100 may be an example of a wireless local area network (WLAN) (also known as a Wi-Fi network, such as 802.11ax) and may include an AP 105 and multiple associated STAs 115. Devices in wireless communications system 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The STAs 115 may represent devices such as mobile stations, wireless communication terminals, phones, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the wireless communications system 100. An extended network station associated with the wireless communications system 100 may be connected to a wired or wireless distribution system that may allow multiple APs 105 to be connected in an ESS. The AP 105 and STAs 115 may support multiple chain configurations for communication. The energy efficiency of the chains configurations may vary based on the communication conditions. According to the techniques described herein, a STA 115 may autonomously adapt to various communication conditions by dynamically selecting chain configuration modes to operate in given the traffic and communication conditions.

In some cases, a STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. In some cases, the coverage area 110 of an AP 105 may be divided into sectors. The wireless communications system 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 125 may include Wi-Fi Direct connections, Wi-Fi Tunneled Direct Link Setup (TDLS) links, and other group connections. STAs 115 and APs 105 may communicate according to the WLAN radio and baseband protocol for physical (PHY) and medium access control (MAC) layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within wireless communications system 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention-based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of a request-to-send (RTS) packet transmitted by a sending STA 115 (or AP 105) and a clear-to-send (CTS) packet transmitted by the receiving STA 115 (or AP 105). This may alert other devices within range of the sender and receiver not to transmit for the duration of the primary transmission. Thus, RTS/CTS may help mitigate a hidden node problem.

An AP 105 may communicate with a STA 115 via uplink and downlink. Uplink transmissions may refer to transmissions from the STA 115 to the AP 105 and downlink transmissions may refer to transmissions from the AP 105 to the STA 115. A number of communication techniques may be used for downlink and uplink transmissions. For example, a wireless device (e.g., an AP 105) may implement beamforming in which the energy of a transmission is focused in a particular direction (e.g., towards a STA 115, or a set of STAs 115). In some cases, single-input-single-output (SISO) techniques may be used for communications between an AP 105 and STA 115 in which both the AP 105 and the STA 115 use a single antenna. In other cases, multiple-input-multiple-output (MIMO) techniques may be used for when the AP 105 and/or STA 115 involved in a communication include multiple antennas.

In some cases, uplink and/or downlink multi-user MIMO (MU-MIMO) may be used. For example, uplink/downlink single-user MIMO (SU-MIMO) may be used in which multiple streams of data are simultaneously communicated (e.g., from an AP 105 to a STA 115) using multiple antennas and beamforming technology. In multi-user MIMO (MU-MIMO), for example downlink MU-MIMO, an AP 105 may simultaneously send multiple streams to multiple STAs 115 by taking advantage of spatial diversity in transmission resources and multiple antennas.

Different chain configurations may be used to implement SISO and MIMO techniques, as well as single-input-multiple-output (SIMO) and multiple-input-single-output (MISO) techniques. For example, a chain configuration that includes one antenna may be used for SISO communications and a chain configuration that uses multiple antennas may be used for MIMO techniques. The power consumption of a chain configuration may be related to the number of chains (e.g., more chains may use more power). Thus, a SISO chain configuration may use less power per unit time than a MIMO chain configuration. The rate at which data can be received may also be related to the number of chains (e.g., more chains may receive data faster). Thus, a MIMO chain configuration may complete data reception faster than a SISO chain configuration.

In some cases, a STA 115 may wait a period of time after the last packet of a received transmission before powering down. If another packet is received during this period of time, the STA 115 may available to receive the packet. If a packet is not received during this period of time, the STA 115 may go into a low power mode. When packets in a downlink transmission are sent to a STA 115 in quick succession, the STA 115 may use a MIMO chain configuration. The use of a MIMO chain configuration may enable the STA 115 to receive the entire transmission quickly and enter a low power mode, which may compensate for the extra power used to perform MIMO techniques. When packets in a downlink transmission are sent to the STA 115 in slow succession, the STA 115 may use a SISO chain configuration. The use of the SISO chain configuration may use less power than a MIMO chain configuration per unit time, which may compensate for a delayed low power mode that is due to the slower receive capabilities of the SISO chain configuration. Thus, according to the techniques discussed herein, a STA 115 may dynamically switch between chain configurations based on communication conditions such as throughput and packet rate.

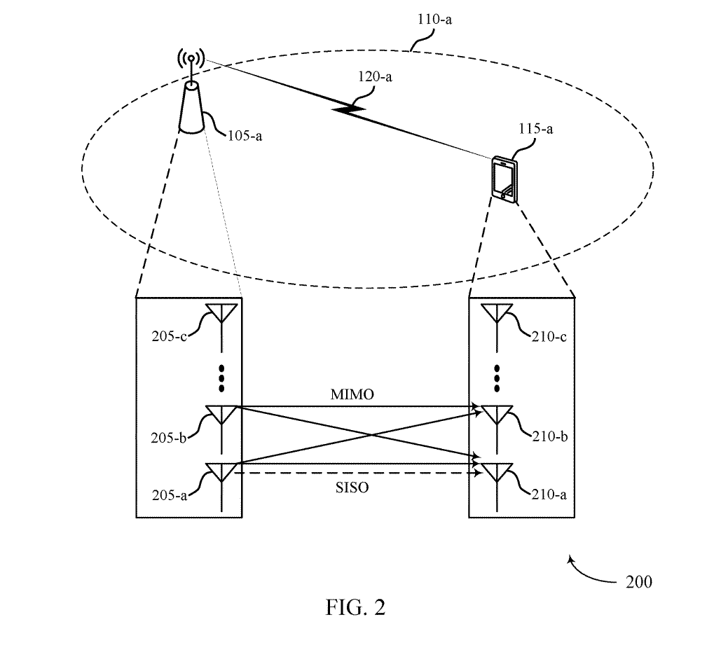

FIG. 2 illustrates an example of a wireless communications system 200 for dynamic chain configuration selection in accordance with various aspects of the present disclosure. Wireless communications system 200 includes an AP 105-a and STA 115-a, which may be examples of the corresponding devices described with reference to FIG. 1. AP 105-a may communicate with wireless devices inside coverage area 110-a; for example, AP 105-a may communicate with STA 115-a over a wireless channel via communication link 120-a. AP 105-a and STA 115-a may be capable of communicating using a variety of chain configuration modes. According to the techniques described herein, STA 115-a may dynamically and autonomously update its chain configuration mode based on communication conditions determined by STA 115-a.

AP 105-a may include multiple antennas 205 (e.g., N antennas). For example, AP 105-a may include antenna 205-a, antenna 205-b, and antenna 205-c. STA 115-a may also include multiple antennas 210. For example, AP 105-a may include antenna 210-a, 210-b, and 210-c. Although shown with the same number of antennas, AP 105-a and STA 115-a may include different numbers of antennas. Each antenna may be coupled with processing circuitry, and the combination may be referred to herein as a chain. In some cases, an antenna may be associated with multiple chains. Each chain may receive a respective spatial stream of data; thus, the signal strength at each chain may be specific to that chain (e.g., each chain may be associated with a respective signal strength). Accordingly, in some cases, a difference in signal strength may occur between chains in a chain configuration. A wireless device may enable (e.g., turn on) or disable (e.g., turn off) different chains to implement various chain configuration modes. A wireless device using a particular chain configuration mode for communications may be said to be operating in, or according to, that particular chain configuration mode.

In some cases, STA 115-a may operate in a chain configuration mode that uses a single chain and antenna. For example, STA 115-a may employ SISO techniques in which STA 115-a uses a single antenna (e.g., antenna 210-c) and chain to receive communications from AP 105-a, which also uses a single antenna (e.g., antenna 205-c) and chain. Such a chain configuration may be referred to herein as a 1×1 chain configuration or 1×1 mode. In another example, STA 115-a may operate in a chain configuration mode that uses a single chain to receive while AP 105-a operates in a chain configuration mode that uses multiple chains to transmit (e.g., a STA 115-a may partake in MISO communications, which may also be referred to as m×1 communications). In general, an m×n chain configuration (or configuration mode or mode) may describe the number of chains used by the respective devices involved in the communication. For example, m chains at a transmitting device and n chains at a receiving device may be used for communications associated with an m×n chain configuration.

In alternative examples, STA 115-a may operate in a chain configuration mode that uses multiple antennas. For example, STA 115-a may employ MIMO techniques in which STA 115-a uses a multiple antennas (e.g., antenna 210-a and antenna 210-b) to receive communications from AP 105-a, which also uses multiple antennas (e.g., antenna 205-a and 205-b) to transmit. Thus, a chain configuration that uses multiple chains may be used for MIMO techniques. When two chains are used per wireless device, the chain configuration may be referred to as a 2×2 chain configuration. MIMO may use a technique called spatial division multiplexing that takes advantage of the multiple transmit and receive chains to send multiple streams of data simultaneously on the same wireless channel, thereby increasing data rate and overall throughput. In another example, STA 115-a may operate in a chain configuration mode that uses multiple chains while AP 105-a may operate in a chain configuration mode that uses a single chain (e.g., a STA 115-a may partake in SIMO communications, which may also be referred to as 1×n communications).

Each chain configuration mode may have energy implications that differ from other chain configuration modes. For example, when actively communicating (e.g., transmitting and receiving), a chain configuration mode that uses multiple chains may consume more power per unit of time compared to a chain configuration mode that uses a single chain. However, a chain configuration mode that uses multiple chains may receive more data per unit of time compared to its single chain counterpart, which may allow the STA 115 to enter low power mode sooner compared to a single chain, and therefore remain in a lower power longer before the next high power mode. Thus, the energy efficiency of a chain configuration mode may vary with communication conditions, such as packet rate. For example, when packet rate is high, the use of multiple chains at STA-a may be more energy efficient than the use of a single chain because the higher power consumption of the multiple chains is compensated for by spending more time in low power mode compared to the single chain. For instance, when AP 105-a has data for STA 115-a and sends packets in quick succession, STA 115-a may use multiple chains to receive data from a transmitting device more quickly and enter a low power mode (e.g., power collapse) sooner than would otherwise be possible using a single chain. Thus, when a packet rate is higher than a certain threshold, a STA 115 using multiple chains, that may consume more power per unit of time compared to a single chain, may spend more time in low power mode, which may result in improved energy efficiency.

Alternatively, when the packet rate is lower than a certain threshold, a STA 115 may improve energy efficiency by using a chain configuration with a single chain. Again, this may be the case due to the tradeoff between power consumption per unit time during active communication and the amount of time the STA 115 is allowed to be in a low power state. A STA 115 that receives packets at a low rate may spend less energy receiving the packets using a single chain opposed to multiple chains, and may spend a comparable amount of time in low power mode, resulting in greater energy efficiency.

A STA 115 may be preconfigured with predetermined threshold packet rates, or may itself determine the threshold packet rates, at which operation using one chain configuration may become more energy efficient than another. The STA 115 may use these predetermined packet rate thresholds to selectively operate in different chain configuration modes. In some cases, the STA 115 may also consider other metrics, such as RSSI, SNR, and/or channel congestion, when selecting a chain configuration mode for operation. The STA 115 may determine values for the metrics from a series of corresponding values that are gathered by monitoring traffic on a wireless channel. For example, the STA 115 may determine a series of values for channel congestion that are based on the energy detected on a wireless channel. In some examples, the STA 115 may use the series of values to calculate an average value for the channel congestion metric.

In another example, the STA 115 may determine a series of values for the RSSI of a chain and compute the average RSSI of the chain using the series of values. In some examples, the STA 115 may use the respective RSSI for each chain in a chain configuration to compute the RSSI difference across the chains, for example as a standard deviation of RSSI. In some cases, the STA 115 may determine an overall RSSI for an entire chain configuration based on a series of RSSI values from the chains included in the chain configuration. To determine a series of RSSI values, the STA 115 may determine the signal strength of one or more received packets (e.g., by an evaluation of the preamble of the packets). After calculating values for the metrics based on the corresponding series of values, the STA 115 may compare the values to corresponding predetermined thresholds. The STA 115 may selectively operate in one of the chain configuration modes based on the comparisons.

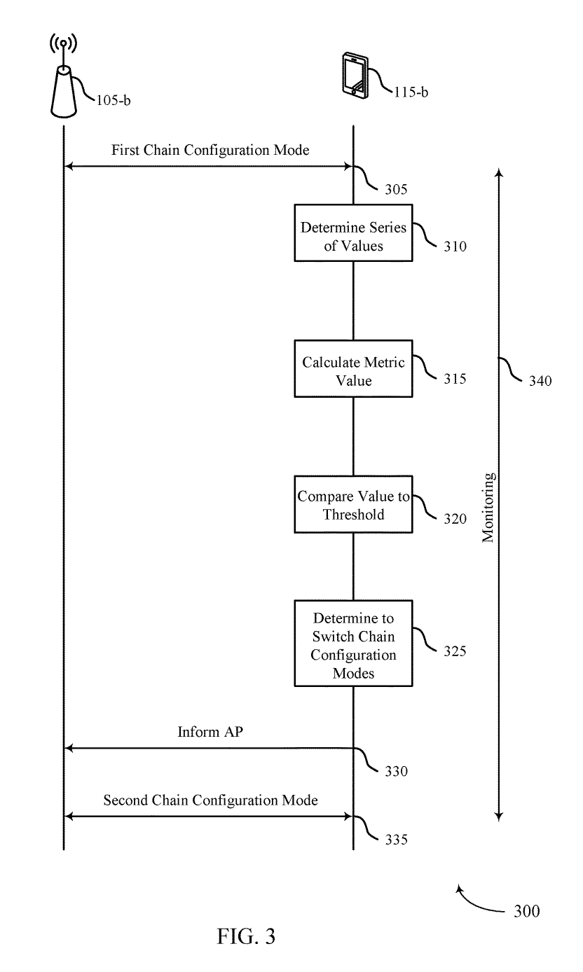

FIG. 3 illustrates an example of a process flow 300 for dynamic chain configuration selection in accordance with various aspects of the present disclosure. Process flow 300 may represent aspects of techniques performed by an AP 105 and STA 115 as described with reference to FIGS. 1-2. STA 115 may include multiple antennas and antenna chains. STA 115 may autonomously select, without a command from AP 105 to do so, a chain configuration mode based on communication conditions as determined from one or more metrics associated with traffic on the wireless channel.

At 305, STA 115-b may participate in communications with AP 105-b using a first chain configuration mode. For example, STA 115-b may transmit packets to AP 105-b and/or receive packets from AP 105-b over a wireless channel. The first chain configuration mode may use a single chain or multiple chains, for example 1×1 modes or 2×2 modes, etc. At 310, STA 115-b may determine a series of values for a metric. The metric may be signal strength (e.g., SNR or RSSI), packet rate, channel congestion, or the signal strength difference across chains of the first chain configuration mode. At 310, STA 115-b may determine the series of values by monitoring traffic on the wireless channel during a monitoring time period 340. For example, STA 115-b may monitor aspects of packets sent, received, or detected on the wireless channel. When the metric is signal strength, STA 115-b may determine the series of values by monitoring the signal strength of received packets (e.g., at a chain-level). When the metric is channel congestion, STA 115-b may determine the series of values by detecting energy from other wireless devices on the wireless channel. When the metric is packet rate, STA 115-b may determine the series of values by monitoring the beginning and end boundaries of received packets. Although the monitoring time period 340 is shown as occurring continuously from 305 to 335, the monitoring time period 340 may occur for intermittent portions of time during process flow 300.

At 315, STA 115-b may calculate a value for the metric based on the series of values. The series of values used in the calculation may represent a portion or subset of the values obtained via the monitoring 340. For example, the series of values used in the calculation may include the x most recent values obtained during the monitoring time period 340. In some cases, the value calculated for the metric may be a moving average. In some cases, the value may be computed by filtering the series of values against an infinite-impulse response (IIR) filter or finite impulse response (FIR) filter. For example, the series of values can be filtered against a 1-tap IIR filter with a higher emphasis on recent values and a lower emphasis on older values. Alternatively, the emphasis can be adapted based on communication conditions.

At 320, STA 115-b may compare the calculated value of the metric to a corresponding predetermined threshold. At 325, STA 115-b may determine to switch chain configuration modes to a second chain configuration mode based on the comparison. For example, STA 115-b may determine to switch from operating in the first chain configuration mode to operating in the second chain configuration mode if the average packet rate exceeds a predetermined average packet rate threshold. At 330, STA 115-b may inform AP 105-b of the new chain configuration mode. For instance, STA 115-b may transmit an explicit indication of the second chain configuration mode (e.g., in a spatial multiplexing power save (SMPS) action frame. Alternatively, STA 115-b may transmit an implicit indication of the second chain configuration mode by embedding the indication in a data frame (e.g., by using receiver operating mode indicator (ROMI) triggers). In other cases, STA 115-b may not inform AP 105-b of the second chain configuration. At 335, STA 115-b may communicate with AP 105-b over the wireless channel using the second chain configuration mode.

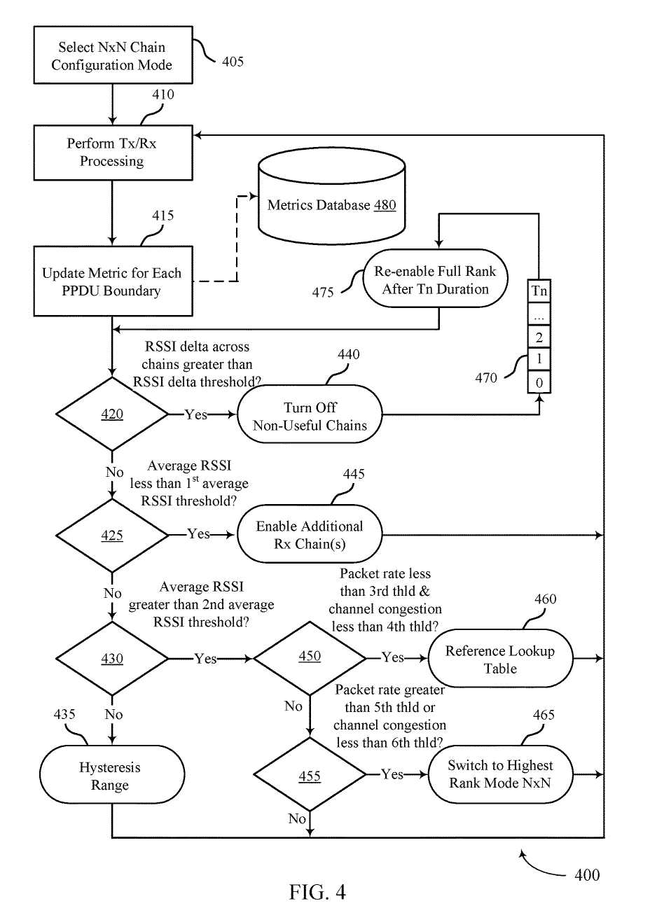

FIG. 4 illustrates an example of a flow diagram 400 for dynamic chain configuration selection in accordance with various aspects of the present disclosure. Flow diagram 400 may represent aspects of techniques performed by a STA 115 as described with reference to FIGS. 1-3. The STA 115 may be capable of operating in various chain configuration modes and may monitor traffic (e.g., continuously or intermittently) on a wireless channel. The STA 115 may monitor traffic on the wireless channel to determine a series of values for one or more metrics, which are then used to compute an overall value for each of the metrics. The STA 115 may be capable of supporting a maximum number of N chains. Thus, the full rank mode, or highest chain configuration mode, supported by STA 115 is N×N.

At 405, the STA 115 may select the full rank N×N chain configuration mode in which to operate. At 410, the STA 115 may perform or handle the transmit and receive (Tx/Rx) processing of packets transmitted and received over a wireless channel. At 415, the

STA 115 may, based on the monitoring and the Tx/Rx processing, update the series of values for each metric (e.g., by storing the series of values in the metrics database 480). In some cases, the STA 115 may compute overall values for the metrics based on the respective series of values. For example, the STA 115 may compute an average value of each of the metrics (e.g., one or more filters may be applied) and may store that average value in the metrics database. Metrics stored by the metrics database 480 may include signal strength (e.g., SNR and/or RSSI), packet rate, channel congestion, and RSSI difference between chains. The metrics database 480 may be updated for each boundary of a physical layer convergence protocol (PLCP) protocol data unit (PPDU), or at slower intervals. The packet rate metric may correspond to a PPDU packet rate, an aggregated medium access control (MAC) protocol data unit (A-MPDU) packet rate, or an aggregated MAC service data unit (A-MSDU) packet rate. In some cases, the metrics database 480 may be updated at the boundaries of each A-MPDU or at the boundaries of each A-MSDU. The RSSI series of values may be captured at the boundaries of PPDUs from the preamble of the PPDUs.

At 420, the STA 115 may determine whether the RSSI delta, or difference, across chains in the N×N chain configuration is greater than a predetermined threshold. If N=2, (e.g., the STA 115 is in a 2×2 chain configuration mode), the STA 115 may directly compare the RSSI value for the first chain to the RSSI value of the second chain. When the RSSI difference between the two chains exceeds a predetermined threshold (e.g., an RSSI delta threshold), the STA 115 may assume that one of the chains is not contributing, or hardly contributing, to reception. Accordingly, the STA 115 may proceed to 440 and turn off, or disable, the chain that has the lowest RSSI. If the RSSI between the two chains are relatively close (e.g., within different threshold), the STA 115 may select which chain to disable based on other constraints (e.g., based on whether or not one of the chains is shared with other wireless technologies, such as Bluetooth or Long Term Evolution (LTE)). If N>2, (e.g., the STA 115 is in a 3×3 or greater mode), the STA 115 may calculate the standard deviation of RSSI across each of the chains of the chain configuration. When the RSSI standard deviation across the chains is greater than a predetermined threshold, the STA 115 may assume that there is great diversity in RSSI across the chains. Accordingly, the STA 115 may proceed to 440 and turn off the chains that have low RSSI (e.g., the chains that are not useful for reception).

After 440, the STA 115 may attempt to go back to the full rank chain configuration mode after a predetermined period of time. For example, the STA 115 may monitor a periodic timer 470. Upon expiry of the periodic timer 470, the STA 115 may, at 475, re-enable chains to operate in the full rank chain configuration mode and return to 420 to determine if channel conditions have changed (e.g., improved). In an alternative example, after 440 the STA 115 may continue to operate in a reduced chain configuration mode for a predetermined period of time before switching to a higher chain configuration mode (which is selected based on the average packet rate).

If the RSSI delta across the chains is not greater than the RSSI delta threshold, the

STA 115 may, at 425, determine whether the average RSSI is less than a first average RSSI threshold. For example, the STA 115 may compare the average RSSI to a predetermined threshold. When the average RSSI is less than the first average RSSI threshold, the STA 115 may, at 445, remain in full rank mode, or enable additional chains (e.g., if the STA 115 is operating in a chain configuration mode that is less than the full rank) to improve diversity gain. After enabling the chains at 445, the STA 115 may return to 410 and perform Tx/Rx processing. When the average RSSI is not less than the first average RSSI threshold, the STA 115 may proceed to 430 and determine whether the average RSSI is greater than a second average RSSI threshold. The second average RSSI threshold may be different than the first RSSI threshold so that a hysteresis is created. If the STA 115 determines that the average RSSI is greater than the second average RSSI threshold, the STA 115 may proceed to 450. If the STA 115 determines that the average RSSI is not greater than the second average RSSI threshold, the STA 115 assumes that the average RSSI is within the hysteresis range set by the two different RSSI thresholds and may proceed to 435 before returning to 410 to perform Tx/Rx processing.

At 450, the STA 115 may determine whether the average packet rate is less than a corresponding average packet rate threshold (e.g., via a comparison between the average packet rate and a third predetermined threshold) and whether the average channel congestion is less than a corresponding average channel congestion threshold (e.g., via a comparison between the average channel congestion and a fourth predetermined threshold). When the STA 115 determines that the average packet rate is less than the third threshold and the average channel congestion is less than the fourth threshold, the STA 115 may reference a lookup table to select an appropriate chain configuration given the values of the average packet rate and channel congestion. After 460, the STA 115 may return to 410 and perform Tx/Rx processing.

When the STA 115 determines that the average packet rate is not less than the third threshold and/or the average channel congestion is not less than the fourth threshold, the STA 115 may proceed to 455. At 455, the STA 115 may determine whether the average packet rate is greater than a fifth predetermined threshold or the average channel congestion is greater than a sixth predetermined threshold. When the STA 115 determines that the average packet rate is greater than a fifth predetermined threshold or the average channel congestion is greater than a sixth predetermined threshold, the STA 115 may proceed to 465. At 465, the STA 115 may switch to, or maintain, operating in the highest rank chain configuration mode. After 465, the STA 115 may return to 410 and perform Tx/Rx processing. If neither of the conditions at 450 are satisfied, the STA 115 may return to 410 and perform Tx/Rx processing.

Although described with reference to RSSI, the techniques described with reference to flow diagram 400 may be implemented for other measures of signal strength, such as SNR. In some cases, the RSSI may be real-time packet RSSI that is adjusted against an ingress modulation and coding scheme (MCS) and/or an error vector magnitude (EVM) factor. In other cases, the RSSI may be based on a beacon RSSI. Additionally, the techniques described herein may be implemented using representations of metric values other than averages.

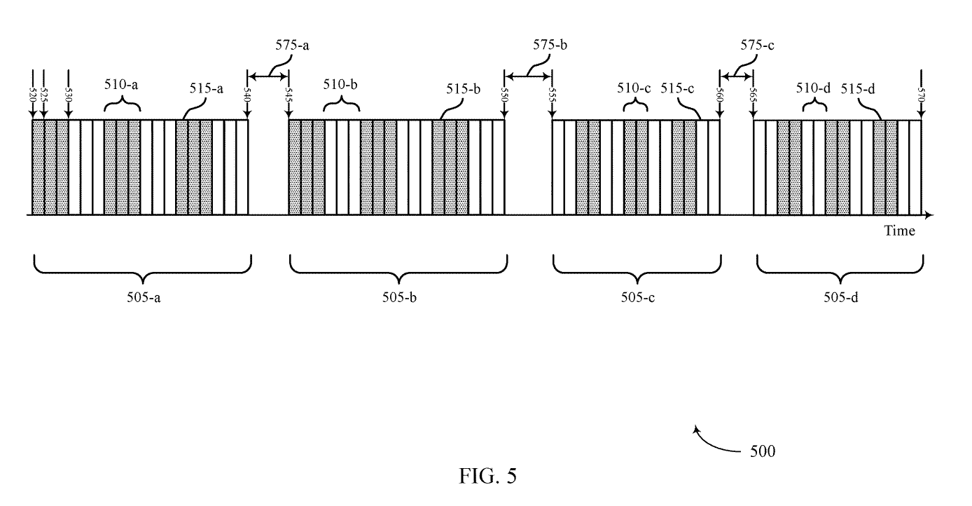

FIG. 5 illustrates an example of a transmission 500 for dynamic chain configuration selection in accordance with various aspects of the present disclosure. Transmission 500 may be an example of communications received by a STA 115 over a wireless channel. Transmission 500 may include a number of PPDUs 505, including PPDU 505-a, PPDU 505-b, PPDU 505-c, and PPDU 505-d. Each PPDU may include a number of A-MPDUs 510. For example, PPDU 505-a may include six A-MPDUs 510-a, PPDU 505-b may include six A-MDPUs 510-b, PPDU 505-c may include seven A-MPDUs 510-c, and PPDU 505-d each include seven A-MPDUs 510-d. An A-MPDU 510 may include one or multiple A-MSDUs 515. For example, the A-MPDUs 510-a in PPDU 505-a include three A-MSDUs 515-a, the A-MPDUs 510-b in PPDU 505-b include three A-MSDUs 515-b, the A-MPDUs 510-c in PPDU 505-c include two A-MSDUs 515-c, and the A-MPDUs 510-d in PPDU 505-d include two A-MSDUs 515-d. In other examples, A-MPDUs 510 may include a different number of A-MSDUs 515.

Each packet sent in transmission 500 may have a beginning, or start, boundary and an end boundary. In some cases, a boundary for several packet types may align. For instance, an A-MSDU 515, an A-MPDU 510, and a PPDU 505 may all begin at the same time, for example at boundary 520. In this case, the A-MSDU 515 may end at boundary 525 and the A-MPDU 510 may end at boundary 530. The PPDU 505 may end at boundary 540. A STA 115 may detect the beginning and end boundaries of PPDUs 505, A-MPDUs 510, and/or A-MSDUs 515. In some cases, the STA 115 may determine a packet rate for a transmission based on the detected boundaries.

According to the techniques described herein, a STA 115 may detect the boundaries for PPDU 505-a (e.g., boundary 520 and boundary 540), the boundaries for PPDU 505-b (e.g., boundary 545 and boundary 550), the boundary for PPDU 505-c (e.g., boundary 555 and boundary 560), and the boundaries for PPDU 505-d (e.g., boundary 565 and boundary 570). The STA 115 may then determine the spacing between each of the PPDUs 505 based on the beginning and end boundaries for subsequent PPDUs 505. For example, the STA 115 may subtract the end boundary of a first PPDU 505 (e.g., the end boundary of PPDU 505-a, which is boundary 540) from the beginning boundary of a following PPDU 505 (e.g., the beginning boundary of PPDU 505-b, which is boundary 545). The difference between the boundaries, referred to as inter-PPDU spacing 575-a, may represent the temporal spacing between the PPDUs 505, which the STA 115 may use to determine the packet rate.

In some cases, the STA 115 may compute a running average for a series of inter-PPDU spacing 575 to determine the average packet rate. For example, the STA 115 may compute an average using inter-PPDU spacing 575-a and inter-PPDU spacing 575-b. In some cases, the STA 115 may update the average packet rate by replacing, in the computation, an inter-PPDU spacing 575 with a newer (e.g., more recently received or calculated) inter-PPDU spacing 575. For example, the STA 115 may replace inter-PPDU spacing 575-a with inter-PPDU spacing 575-c when calculating an updated average packet rate. Although described with reference to two inter-PPDU spacing 575, the average packet rate may be calculated using any positive integer number of inter-PPDU spaces (e.g., a number between 2 and 100). In some cases, the size of the inter-PPDU spaces may be configurable by an AP 105 and/or STA 115. Averaging the packet rate over an larger number of inter-PPDU spacing 575 may increase precision, but may be slower, for example due to increased computation complexity, compared to an average packet rate that is computed using a smaller number of inter-PPDU spacing 575.

Although described with reference to PPDUs 505, a similar process to determine packet rate may be implemented using A-MPDUs 510 or A-MSDUs 515. For example, a STA 115 may subtract the end boundary of the last A-MSDU 515 in a first PPDU 505 from the beginning boundary of the first A-MSDU 515 in a following PPDU 505. The difference between the boundaries may represent the temporal spacing between the A-MSDUs 515, which the STA 115 may use to determine the packet rate.

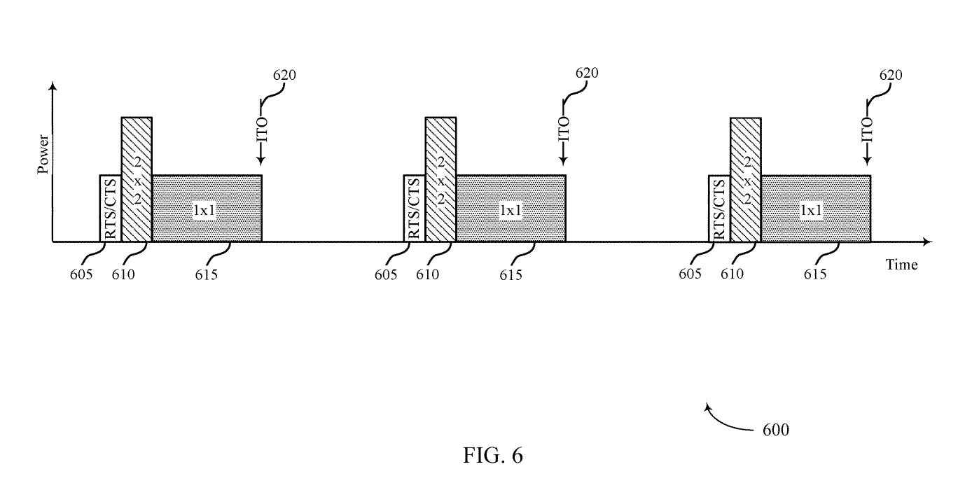

FIG. 6 illustrates an example of a timing diagram 600 that supports dynamic chain configuration selection in accordance with various aspects of the present disclosure. Timing diagram 600 may represent aspects of techniques performed by a STA 115 as described with reference to FIGS. 1-5. A STA 115 implementing aspects of timing diagram 600 may dynamically switch between two different chain configuration modes based on the communication activity of the STA 115.

A wireless device (e.g., a STA 115) may send control signals (e.g., control messages) over a wireless channel to gain and reserve access to the wireless channel. For example, a STA 115 with data to transmit may send a RTS signal over the wireless channel to the intended recipient of the data (e.g., an AP 105). In response to the RTS, the AP 105 may send a CTS signal that indicates to the STA 115 that the STA 115 is allowed to transmit over the wireless channel. The CTS may also include a time value that alerts other wireless devices to refrain from accessing the wireless channel while the STA 115 transmits the data. RTS and CTS signals may be referred to herein as channel reservation transmissions or control transmissions. Control transmissions may also include other types of signals that convey control information to or from STA 115.

According to the techniques described herein, a STA 115 may send and receive RTS/CTS signals (e.g., control transmissions) during channel reservation interval 605 using a first chain configuration mode (e.g., a 1×1 chain configuration mode). The exchange of RTS/CTS signals during channel reservation interval 605 may be referred to as the search phase and may be associated with relatively low throughput and/or packet rate. Accordingly, using a 1×1 chain configuration mode during search phases may reduce power consumption compared to higher rank chain configurations. Following a search phase, the STA 115 may, during an awake interval 610 reserved by the RTS/CTS signals, transmit and/or receive communications (e.g., packets of information) over the wireless channel. During awake interval 610, the STA 115 may operate in a 2×2 chain configuration mode (e.g., the STA 115 may switch chain configuration modes from the 1×1 mode used during channel reservation interval 605 to a 2×2 mode used during awake interval 610). The STA 115 may enter a 2×2 chain configuration mode to actively communicate (e.g., transmit or receive) on the wireless channel reserved by the RTS/CTS signals during awake interval 610. Communications during awake interval 610 may be associated with relatively high throughput and/or packet rate. Therefore, using a 2×2 chain configuration mode during awake intervals 610 may reduce power consumption compared to lower rank chain configurations.

Subsequent to the awake interval 610 (e.g., after the channel reservation expires), the STA 115 may switch back to a 1×1 chain configuration mode. The inactivity interval 615 may be a duration of time that the STA 115 remains in the awake mode after the last received/transmitted packet and listens subsequent transmissions. The inactivity interval 615 may last until the STA 115 receives a packet, or until an inactivity timer expires. When the inactivity timer expires, the STA 115 may, at inactivity time out (ITO) 620, implement power collapse in which the STA 115 enters a low power mode (e.g., a sleep mode).

In some cases, the inactivity timer may be dynamically adjusted (e.g., on a per-packet basis) based on the packet rate (e.g., the packet arrival rate) and/or channel congestion. One method for estimating channel congestion may be based on tracking physical (PHY) layer channel observations during an awake state. A STA 115 may record various PHY layer statistics while monitoring traffic and/or energy on a wireless channel. For example, a first counter may be up-counted when energy is detected on the channel, whether caused by the STA 115 or other wireless devices of the wireless network. A second counter may be up-counted when energy is detected on the channel and Wi-Fi packets are detected on the channel, whether caused by the STA 115 or other wireless devices of the wireless network. A third counter may be up-counted by output of the PHY transmission process in the STA 115, when the STA 115 is not engaged in reception activities, including idle-listen, and the transmission blocks are active.

These counters may be continuously updated by suitable hardware and loaded into respective registers. Manipulation of the data in the registers may result in determining the following metrics: Metric I (channel congestion metric)—amount of time the channel has been busy in a given time due to transmission or reception activities by devices other than the device itself; Metric II (channel reception activity metric)—amount of time the device spent receiving frames directed to itself (requires some software level processing, rather than being directly evident from the registers); and Metric III (channel transmission activity metric)—amount of time the device itself spent transmitting frames. In some cases, a STA 115 may select a chain configuration mode to operate in based on Metric I, Metric II, and/or Metric III. Alternatively, the STA 115 may select a chain configuration mode based on other representations of channel congestion, which may be determined in various ways.

In some examples, a STA 115 may enable and disable the techniques described with reference to FIG. 6. For example, the STA 115 may dynamically switch between operating in two chain configurations of a chain configuration mode to operating in a single chain configuration in a chain configuration mode. For instance, the STA 115 may support two chain configuration modes: a first chain configuration mode that includes two different chain configurations (e.g., a 1×1 chain configuration and a 2×2 chain configuration) and a second chain configuration mode that includes a single chain configuration (e.g., a 1×1 chain configuration). When the STA 115 is operating in the first chain configuration mode, the STA 115 may listen for a control transmission using the first chain configuration and communicate on the wireless channel using the second chain configuration. When the STA 115 is operating in the second chain configuration mode, the STA 115 may communicate using the third chain configuration. The STA 115 may dynamically switch between operating in the first and second chain configuration modes as described herein.

When implemented with the techniques described herein, adjustment of the inactivity timer may serve to further reduce power consumption. Although described with reference to 1×1 and 2×2 chain configuration modes, the techniques described with respect to FIG. 6 may be applied to any combination of chain configuration modes where the lower chain configuration mode is used during the channel reservation interval 605 and inactivity interval 615, and the higher chain configuration mode is used during the awake interval 610.

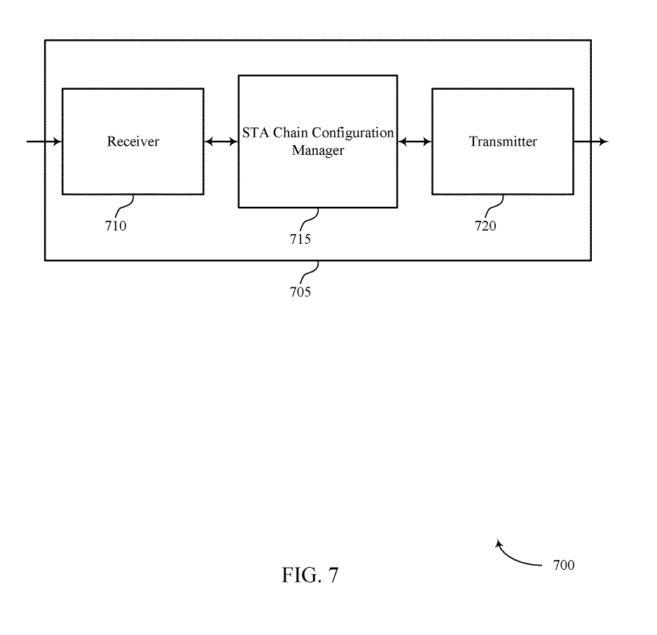

FIG. 7 shows a block diagram 700 of a device 705 that supports dynamic chain configuration selection in accordance with various aspects of the present disclosure. Device 705 may be an example of aspects of a STA 115 as described with reference to FIGS. 1-3. Device 705 may include receiver 710, chain configuration manager 715, and transmitter 720. Device 705 may also include one or more processors, memory coupled with the one or more processors, and instructions stored in the memory that are executable by the one or more processors to enable the one or more processors to perform the chain configuration selection features discussed herein. Each of these components may be in communication with one another (e.g., via one or more buses).

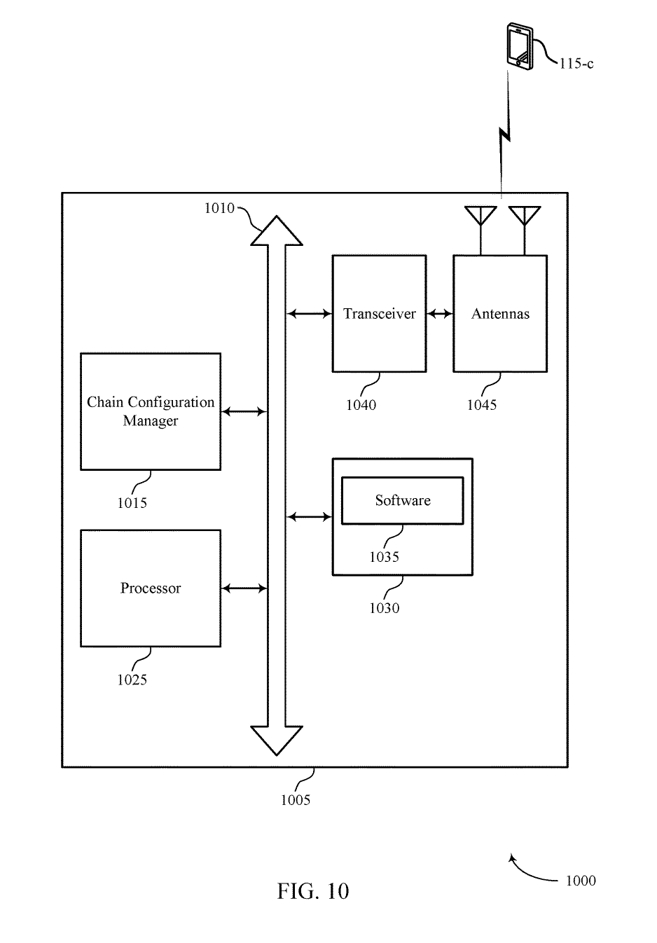

The receiver 710 may receive information such as packets, user data, or control information associated with various information channels (e.g., control channels, data channels, and information related to dynamic chain configuration selection, etc.). For example, the receiver 710 may receive packets that are sent from an AP 105 over a wireless channel. The receiver 710 may support reception of packets using various chain configuration modes, include a single chain configuration mode and multi-chain configuration modes. The receiver 710 may also be used to detect energy on a wireless channel. Thus, the receiver 710 may facilitate monitoring of a wireless channel as described herein. Information may be passed from the receiver 710 to other components of the device. The receiver 710 may be an example of aspects of the transceiver 1040 described with reference to FIG. 10.

The chain configuration manager 715 may monitor traffic on a wireless channel and determine a series of values for a first metric associated with the monitored traffic. Chain configuration manager 715 may switch from operating the device 705 in a first chain configuration mode to operating the device 705 in a second chain configuration mode to communicate on the wireless channel based on the determined series of values for the first metric. The first chain configuration mode may correspond to a SISO mode, a MIMO mode, a SIMO mode, or a MISO mode, and the second chain configuration mode may correspond to a different mode than the first chain configuration mode. The chain configuration manager 715 may be an example of aspects of the chain configuration manager 1015 described with reference to FIG. 10. In some cases, the chain configuration manager 715 may be a processor. The processor may be coupled with memory and execute instructions stored in the memory that enable the processor to perform or facilitate the communication pattern detection and mitigation features discussed herein.

The transmitter 720 may transmit signals generated by other components of the device. For example, the transmitter 720 may transmit indications of the chain configuration mode for the device 705. The transmitter 720 may support transmissions using a variety of chain configuration modes, including single-chain and multi-chain modes. In some examples, the transmitter 720 may be collocated with a receiver 710 in a transceiver module. For example, the transmitter 720 may be an example of aspects of the transceiver 1040 described with reference to FIG. 10. The transmitter 720 may include a single antenna, or it may include a set of antennas.

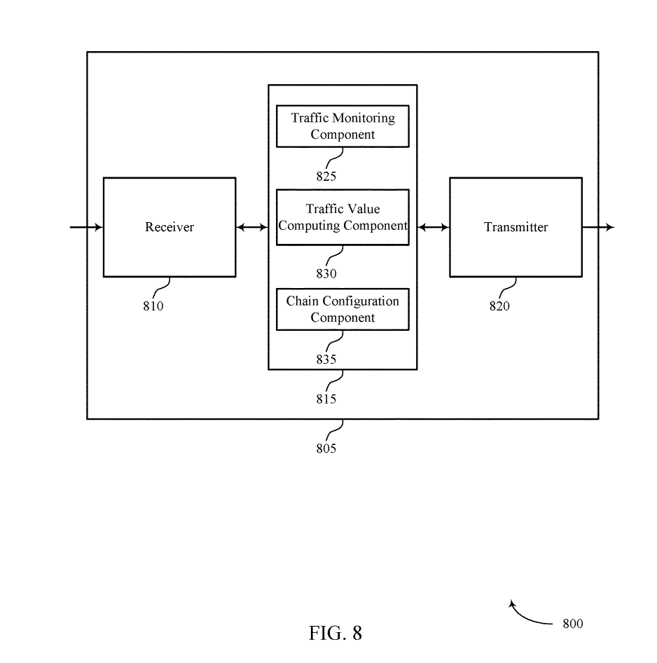

FIG. 8 shows a block diagram 800 of a device 805 that supports dynamic chain configuration selection in accordance with various aspects of the present disclosure. Device 805 may be an example of aspects of a device 705 or a STA 115 as described with reference to FIGS. 1-3 and 7. Device 805 may include receiver 810, chain configuration manager 815, and transmitter 820. Device 805 may also include one or more processors, memory coupled with the one or more processors, and instructions stored in the memory that are executable by the one or more processors to enable the one or more processors to perform the chain configuration selection features discussed herein. Each of these components may be in communication with one another (e.g., via one or more buses).

The receiver 810 may receive information such as packets, user data, or control information associated with various information channels (e.g., control channels, data channels, and information related to dynamic chain configuration selection, etc.). Information may be passed on to other components of the device. The receiver 810 may be an example of aspects of the transceiver 1040 described with reference to FIG. 10.

The chain configuration manager 815 may be responsible for dynamic switching of chain configurations based on traffic conditions, communication conditions, and other metrics such as described herein. The chain configuration manager 815 may include traffic monitoring component 825, traffic value computing component 830, and chain configuration component 835. The chain configuration manager 815 may be an example of aspects of the chain configuration manager 1015 described with reference to FIG. 10.

The traffic monitoring component 825 may monitor traffic on a wireless channel. Monitoring the traffic may include determining the signal strength of a received packet based on a preamble of the received packet. Monitoring the traffic may include detecting energy from other wireless devices on the wireless channel. In some cases, the traffic monitoring component 825 may be a processor (e.g., a transceiver processor, or a radio processor, or a receiver processor). The processor may be coupled with memory and execute instructions stored in the memory that enable the processor to perform or facilitate the traffic monitoring features discussed herein. A transceiver processor may be collocated with and/or communicate with (e.g., direct the operations of) a transceiver of the device 805. A radio processor may be collocated with and/or communicate with (e.g., direct the operations of) a radio (e.g., a Wi-Fi radio) of the device 805. A receiver processor may be collocated with and/or communicate with (e.g., direct the operations of) a receiver of the device 805.

The traffic value computing component 830 may determine a series of values for a first metric associated with the monitored traffic. The first metric may be SNR, RSSI, packet rate, channel congestion, or a difference between RSSI across chains of the first chain configuration mode. In some cases, the first metric is a PPDU packet rate which is determined by detecting the beginning and end boundaries of received PPDU packets. In some cases, the traffic value computing component 830 may be a processor. The processor may be coupled with memory and execute instructions stored in the memory that enable the processor to perform or facilitate the series determination features discussed herein.

The chain configuration component 835 may switch from operating the device 805 in a first chain configuration mode to operating the device 805 in a second chain configuration mode to communicate on the wireless channel based on the determined series of values for the first metric. In some cases, the chain configuration component 835 may switch from operating the device 805 in the second chain configuration mode to operating the device 805 in the first chain configuration mode based on a comparison of a second value for a second metric to a second predetermined threshold. In some cases, the chain configuration component 835 may be a processor (e.g., a transceiver processor or a radio processor). The processor may be coupled with memory and execute instructions stored in the memory that enable the processor to perform or facilitate the chain configuration selection features discussed herein.

In some cases, the chain configuration component 835 may, upon determining to switch from operating the device 805 in a first chain configuration mode to operating the device 805 in a second chain configuration mode, may determine to operate in a SMPS mode based at least in part on the determination to switch. The chain configuration component 835 may then switch from operating the wireless device in the first chain configuration mode to operating the wireless device in the second chain configuration mode after determining to operate in the SMPS mode

The transmitter 820 may transmit signals generated by other components of the device. In some examples, the transmitter 820 may be collocated with a receiver 810 in a transceiver module. For example, the transmitter 820 may be an example of aspects of the transceiver 1040 described with reference to FIG. 10. The transmitter 820 may include a single antenna, or it may include a set of antennas.

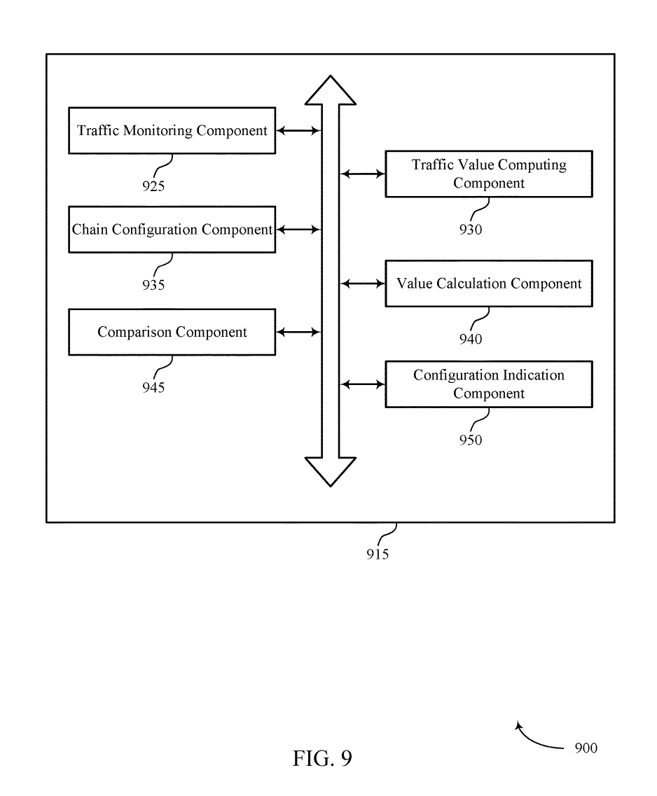

FIG. 9 shows a block diagram 900 of a chain configuration manager 915 that supports dynamic chain configuration selection in accordance with various aspects of the present disclosure. The chain configuration manager 915 may be an example of aspects of a chain configuration manager 715, a chain configuration manager 815, or a chain configuration manager 1015 described with reference to FIGS. 7, 8, and 10. The chain configuration manager 915 may include traffic monitoring component 925, traffic value computing component 930, and chain configuration component 935. Each of these modules may communicate, directly or indirectly, with one another (e.g., via one or more buses).

The traffic monitoring component 925 may monitor traffic on a wireless channel. In some cases, monitoring the traffic includes determining the signal strength of a received packet based on a preamble of the received packet. In some cases, monitoring the traffic includes detecting energy from other wireless devices on the wireless channel. In some cases, monitoring the traffic includes detecting an end boundary of a PPDU packet and detecting a beginning boundary of a following PPDU packet. The traffic monitoring component 925 may pass information related to, or derived from, the monitored traffic to other components of the chain configuration manager 915 (e.g., the traffic value computing component 930). In some cases, the traffic monitoring component 925 may be a processor (e.g., a transceiver processor, or a radio processor, or a receiver processor).

The traffic value computing component 930 may receive information from the traffic monitoring component 925 and determine a series of values for a first metric associated with the monitored traffic. In some cases, the first metric is a signal strength (SNR or RSSI). In other cases, the first metric may be a packet rate, a channel congestion, or a difference between RSSI across chains of a first chain configuration mode. When the first metric is packet rate, the packet rate may be a PPDU packet rate, an A-MPDU packet rate, or an A-MSDU packet rate. A PPDU packet rate may be based on the detected beginning and end boundaries of received PPDUs. The traffic value computing component 930 may pass the series of values to other components of the chain configuration manager 915 (e.g., to a metrics databased such as described with reference to FIG. 4, or to the value calculation component 940). In some cases, the traffic value computing component 930 may determine a series of values for several of the metrics described herein (e.g., the traffic value computing component 930 may determine a second series of values for a second metric associated with the monitored traffic). In some cases, the traffic value computing component 930 may be a processor. The processor may be coupled with memory and execute instructions stored in the memory that enable the processor to perform or facilitate the series determination features discussed herein.

The chain configuration component 935 may switch from operating the device in a first chain configuration mode to operating the device in a second chain configuration mode to communicate on a wireless channel based on a series of values for the first metric. In some cases, for example when the first chain configuration mode includes a single chain and the second chain configuration mode includes multiple chains, the switching is based on the average packet rate exceeding the first predetermined threshold. In some cases, for example when the first chain configuration mode includes a single chain and the second chain configuration mode includes multiple chains, the chain configuration component 935 may switch from operating in the second chain configuration mode to operating in the first chain configuration mode (e.g., if the average packet rate falls below a second predetermined threshold).

In some cases, the chain configuration component 935 may receive the results of comparisons from comparison component 945. For example, the chain configuration component 935 may receive the results of a comparison between the first value of the first metric to a first predetermined threshold. In such cases, the chain configuration component 935 may switch chain configuration modes based on a result of the comparison. In another example, the chain configuration component 935 may also receive the results of a comparison of the second value for the second metric to a second predetermined threshold. In such cases, the chain configuration component 935 may switch chain configuration modes based on a result of the comparison. In some cases, the chain configuration component 935 may receive information that the standard deviation of signal strength across chains operated in the first chain configuration is greater than a predetermined threshold value. In such cases, the chain configuration component 935 may identify one or more of the chains that are causing the standard deviation of the signal strength to be greater than the predetermined threshold and turn off the chain(s). For example, the chain configuration component 935 may turn off one or more of the chains with a signal strength below a second predetermined threshold.

In some cases, the chain configuration component 935 may receive information that the signal strength is less than a predetermined threshold value. In such cases, switching chain configuration modes includes enabling at least one additional chain. In some case, the chain configuration component 935 may receive information that the packet rate is greater than a first predetermined threshold or that the channel congestion is greater than a second predetermined threshold. In some cases, the second chain configuration mode includes a maximum number of chains supported by the device.

The chain configuration component 935 may switch chain configuration modes based on a determined series of values for a first metric and a determined series of values for a second metric. For example, chain configuration component 935 may select to operate in at least one of the first chain configuration mode or the second chain configuration mode based on a packet rate value and a channel congestion value. In some examples, for instance when the first chain configuration mode includes a single chain and the second chain configuration mode includes multiple chains, the chain configuration component 935 may operate in the first chain configuration mode by listening for a control transmission (e.g., a channel reservation transmission) on the wireless channel using a first chain configuration. The chain configuration component 935 may continue to operate in the first chain configuration mode by communicating on the wireless channel using a second chain configuration. The communication may be based on the control transmission. The chain configuration component 935 may switch to operating in the second chain configuration mode by communicating on the wireless channel using a third chain configuration. In some cases, the chain configuration component 935 may be a processor (e.g., a transceiver processor or a radio processor).

The value calculation component 940 may calculate a first value associated with the first metric based on a series of values associated with monitored traffic (e.g., a series of values received from traffic value computing component 930). In some cases, calculating the first value includes determining a moving average for the first metric during a first time period based on one or more values of the series of values. The value calculation component 940 may pass the first value for the first metric to other components of the chain configuration manager 915 (e.g., to a metrics databased such as described with reference to FIG. 4 or the comparison component 945). In some examples, the value calculation component 940 may calculate a second value for a second metric (e.g., based on a second series of values obtain by monitoring traffic on the wireless channel). In some cases, the value calculation component 940 may determine values for several of the metrics described herein. In some cases, the value calculation component 940 may be a processor. The processor may be coupled with memory and execute instructions stored in the memory that enable the processor to perform or facilitate the metric value computation features discussed herein.

The comparison component 945 may receive values for metrics from the value calculation component 940 (e.g., the comparison component 945 may receive the first value for the first metric). The comparison component 945 may compare the first value for the first metric to a first predetermined threshold. The comparison component 945 may pass the results of the comparison, and the results of other comparisons of other metric values, to components of the chain configuration manager 915 (e.g., to chain configuration component 935). In some examples, the comparison component 945 may compare a second value for the second metric to a second predetermined threshold. In some cases, the comparison component 945 may determine that a standard deviation of a signal strength across chains operated in the first chain configuration mode is greater than a predetermined threshold. In some examples, the comparison component 945 may determine that the packet rate is greater than a first predetermined threshold or the channel congestion is greater than a second predetermined threshold. In some cases, the comparison component 945 may determine that the signal strength difference between chains is greater than a first predetermined threshold. In some cases, determining the signal strength difference is greater than a first predetermined threshold may include determining a standard deviation of signal strength across chains operated in the first chain configuration mode. Additionally or alternatively, the comparison component 945 may determine that the packet rate is less than a first predetermined threshold or the channel congestion is less than a second predetermined threshold. In some cases, comparison component 945 may be a processor. The processor may be coupled with memory and execute instructions stored in the memory that enable the processor to perform or facilitate the comparison features discussed herein.

The configuration indication component 950 may facilitate transmissions that indicate the operating chain configuration mode of the device. For example, the configuration indication component 950 may communicate with a transmitter to transmit an indication of the first chain configuration mode or the second chain configuration mode, to an AP. The indication may include a SMPS action frame. Alternatively, the indication may be embedded in a data frame. In some cases, the configuration indication component 950 may be a processor (e.g., a transceiver processor, or a radio processor, or a transmitter processor). The processor may be coupled with memory and execute instructions stored in the memory that enable the processor to perform or facilitate the chain configuration indication features discussed herein. A transmitter processor may be collocated with and/or communicate with (e.g., direct the operations of) a transmitter of the device.

FIG. 10 shows a diagram of a system 1000 including a device 1005 that supports dynamic chain configuration selection in accordance with various aspects of the present disclosure. Device 1005 may be an example of a device 705, device 805, or a STA 115 as described above, e.g., with reference to FIGS. 1-3, 7, and 8. The device 1005 may support operation of various chain configurations such as described herein.

Device 1005 may include components for bi-directional voice and data communications including components for transmitting and receiving communications, including chain configuration manager 1015, processor 1025, memory 1030, software 1035, transceiver 1040, and antennas 1045. The processor 1025 may include an intelligent hardware device, (e.g., a central processing unit (CPU), a microcontroller, an application specific integrated circuit (ASIC), etc.). The memory 1030 may include random access memory (RAM) and read only memory (ROM). The memory 1030 may store computer-readable, computer-executable software 1035 including instructions that, when executed, cause the processor to perform various functions described herein. In some cases, the memory 1030 can contain, among other things, a Basic Input-Output system (BIOS) which may control basic hardware and/or software operation such as the interaction with peripheral components or devices.

Software 1035 may include code to implement aspects of the present disclosure, including code to support dynamic chain configuration selection. Software 1035 can be stored in a non-transitory computer-readable medium such as system memory or other memory. In some cases, the software 1035 may not be directly executable by the processor but may cause a computer (e.g., when compiled and executed) to perform functions described herein. The transceiver 1040 may communicate bi-directionally, via one or more antennas, wired, or wireless links as described above. For example, the transceiver 1040 may represent a wireless transceiver and may communicate bi-directionally with another wireless transceiver. The transceiver 1040 may also include a modem to modulate the packets and provide the modulated packets to the antennas 1045 for transmission (e.g., to STA 115−), and to demodulate packets received from the antennas. In some cases, the wireless device may include a single antenna 1045. However, in some cases the device may have more than one antenna 1045, which may be capable of concurrently transmitting or receiving multiple wireless transmissions.

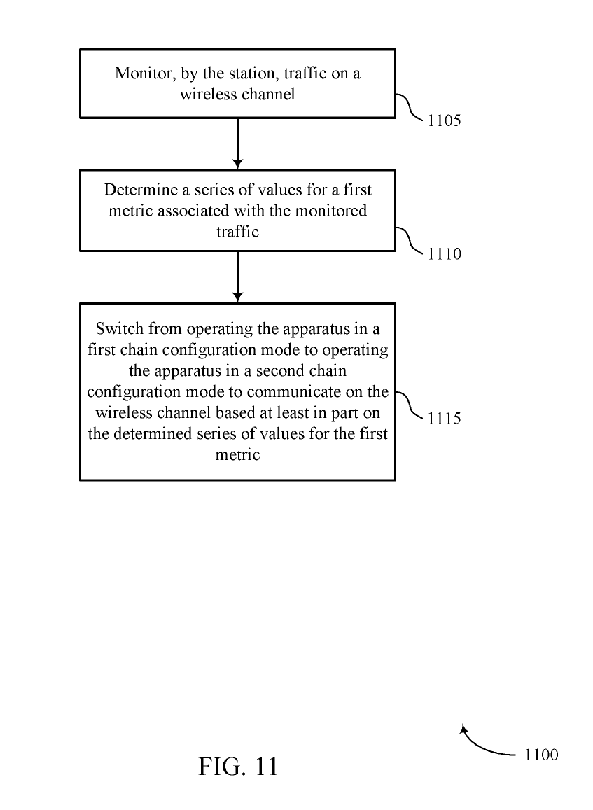

FIG. 11 shows a flowchart illustrating a method 1100 for dynamic chain configuration selection in accordance with various aspects of the present disclosure. The operations of method 1100 may be implemented by a STA 115 or its components as described herein. For example, the operations of method 1100 may be performed by a chain configuration manager as described with reference to FIGS. 7 through 9. In some examples, a STA 115 may execute a set of codes to control the functional elements of the device to perform the functions described below. Additionally or alternatively, the STA 115 may perform aspects the functions described below using special-purpose hardware.

At block 1105, the method may include monitoring, by the STA 115, traffic on a wireless channel. The operations of block 1105 may be performed according to the methods described with reference to FIGS. 2 through 6. In certain examples, the operations of block 1105 may be performed by a traffic monitoring component as described with reference to FIGS. 7 through 9. At block 1110, the method may include determining a series of values for a first metric associated with the monitored traffic. The operations of block 1110 may be performed according to the methods described with reference to FIGS. 2 through 6. In certain examples, the operations of block 1110 may be performed by a traffic value computing component as described with reference to FIGS. 7 through 9.

At block 1115, the method may include the STA 115 switching from operating in a first chain configuration mode to operating in a second chain configuration mode to communicate on the wireless channel based on the determined series of values for the first metric. The operations of block 1115 may be performed according to the methods described with reference to FIGS. 2 through 6. In certain examples, the operations of block 1115 may be performed by a chain configuration component as described with reference to FIGS. 7 through 9.

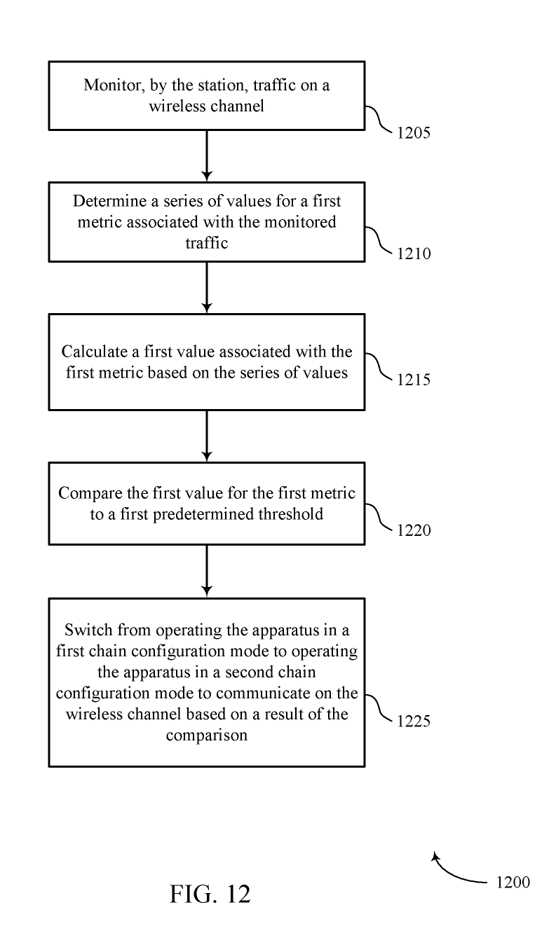

FIG. 12 shows a flowchart illustrating a method 1200 for dynamic chain configuration selection in accordance with various aspects of the present disclosure. The operations of method 1200 may be implemented by a STA 115 or its components as described herein. For example, the operations of method 1200 may be performed by a chain configuration manager as described with reference to FIGS. 7 through 9. In some examples, a STA 115 may execute a set of codes to control the functional elements of the device to perform the functions described below. Additionally or alternatively, the STA 115 may perform aspects the functions described below using special-purpose hardware.

At block 1205, the method may include monitoring, by the STA 115, traffic on a wireless channel. The operations of block 1205 may be performed according to the methods described with reference to FIGS. 2 through 6. In certain examples, the operations of block 1205 may be performed by a traffic monitoring component as described with reference to FIGS. 7 through 9. At block 1210, the method may include determining a series of values for a first metric associated with the monitored traffic. The operations of block 1210 may be performed according to the methods described with reference to FIGS. 2 through 6. In certain examples, the operations of block 1210 may be performed by a traffic value computing component as described with reference to FIGS. 7 through 9.

At block 1215, the method may include calculating a first value associated with the first metric based on the series of values. The operations of block 1215 may be performed according to the methods described with reference to FIGS. 2 through 6. In certain examples, the operations of block 1215 may be performed by a value calculation component as described with reference to FIGS. 7 through 9.

At block 1220, the method may include comparing the first value for the first metric to a first predetermined threshold. The operations of block 1220 may be performed according to the methods described with reference to FIGS. 2 through 6. In certain examples, the operations of block 1220 may be performed by a comparison component as described with reference to FIGS. 7 through 9. At block 1225, the method may include the STA 115 switching from operating in a first chain configuration mode to operating in a second chain configuration mode to communicate on the wireless channel based on a result of the comparison. The operations of block 1225 may be performed according to the methods described with reference to FIGS. 2 through 6. In certain examples, the operations of block 1225 may be performed by a configuration switching component as described with reference to FIGS. 7 through 9.

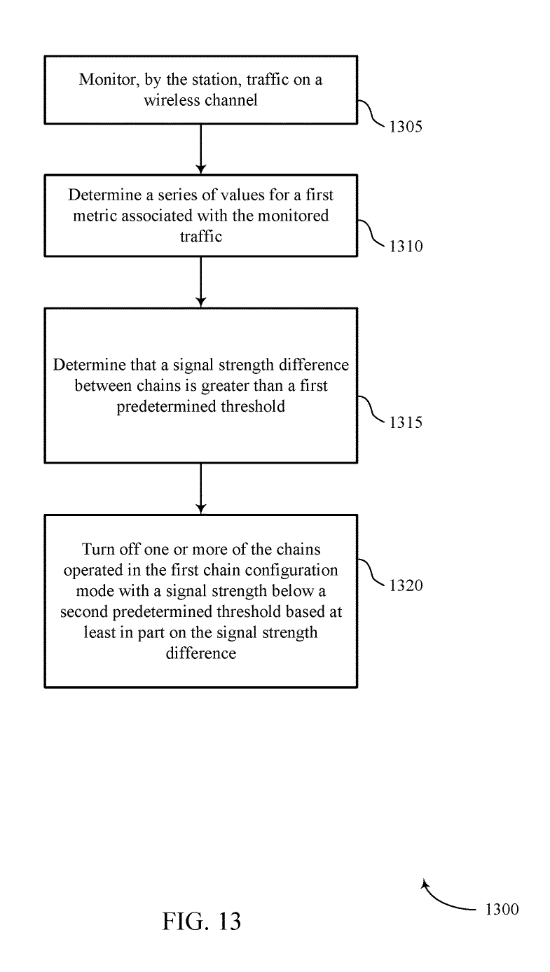

FIG. 13 shows a flowchart illustrating a method 1300 for dynamic chain configuration selection in accordance with various aspects of the present disclosure. The operations of method 1300 may be implemented by a STA 115 or its components as described herein. For example, the operations of method 1300 may be performed by a chain configuration manager as described with reference to FIGS. 7 through 9. In some examples, a STA 115 may execute a set of codes to control the functional elements of the device to perform the functions described below. Additionally or alternatively, the STA 115 may perform aspects the functions described below using special-purpose hardware.

At block 1305, the method may include monitoring, by the STA 115, traffic on a wireless channel. The operations of block 1305 may be performed according to the methods described with reference to FIGS. 2 through 6. In certain examples, the operations of block 1305 may be performed by a traffic monitoring component as described with reference to FIGS. 7 through 9. At block 1310, the method may include determining a series of values for a first metric associated with the monitored traffic. The first metric may be a signal strength. The operations of block 1310 may be performed according to the methods described with reference to FIGS. 2 through 6. In certain examples, the operations of block 1310 may be performed by a traffic value computing component as described with reference to FIGS. 7 through 9.

At block 1315, the method may include determining that a signal strength difference between chains is greater than a first predetermined threshold. The operations of block 1315 may be performed according to the methods described with reference to FIGS. 2 through 6. In certain examples, the operations of block 1315 may be performed by a comparison component as described with reference to FIGS. 7 through 9.

At block 1320, the method may include turning off one or more of the chains operated in the first chain configuration mode with a signal strength below a predetermined threshold based on the signal strength difference. The operations of block 1320 may be performed according to the methods described with reference to FIGS. 2 through 6. In certain examples, the operations of block 1320 may be performed by a chain configuration component as described with reference to FIGS. 7 through 9.

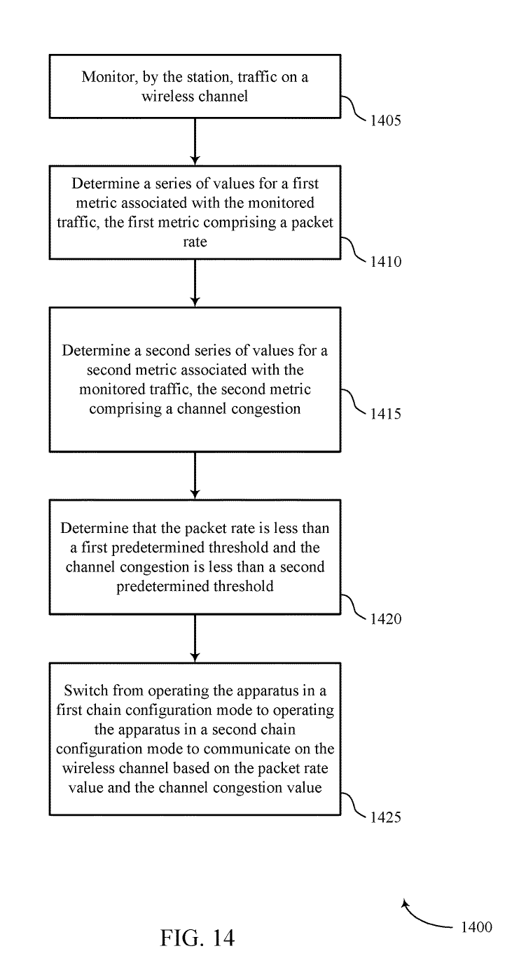

FIG. 14 shows a flowchart illustrating a method 1400 for dynamic chain configuration selection in accordance with various aspects of the present disclosure. The operations of method 1400 may be implemented by a STA 115 or its components as described herein. For example, the operations of method 1400 may be performed by a chain configuration manager as described with reference to FIGS. 7 through 9. In some examples, a STA 115 may execute a set of codes to control the functional elements of the device to perform the functions described below. Additionally or alternatively, the STA 115 may perform aspects the functions described below using special-purpose hardware.

At block 1405, the method may include monitoring, by the STA 115, traffic on a wireless channel. The operations of block 1405 may be performed according to the methods described with reference to FIGS. 2 through 6. In certain examples, the operations of block 1405 may be performed by a traffic monitoring component as described with reference to FIGS. 7 through 9. At block 1410, the method may include determining a series of values for a first metric associated with the monitored traffic. The first metric may be a packet rate. The operations of block 1410 may be performed according to the methods described with reference to FIGS. 2 through 6. In certain examples, the operations of block 1410 may be performed by a traffic value computing component as described with reference to FIGS. 7 through 9.

At block 1415, the method may include determining a second series of values for a second metric associated with the monitored traffic. The second metric may be a channel congestion. The operations of block 1415 may be performed according to the methods described with reference to FIGS. 2 through 6. In certain examples, the operations of block 1415 may be performed by the traffic value computing component as described with reference to FIGS. 7 through 9.

At block 1420, the method may include determining that the packet rate is less than a first predetermined threshold and the channel congestion is less than a second predetermined threshold. The operations of block 1420 may be performed according to the methods described with reference to FIGS. 2 through 6. In certain examples, the operations of block 1420 may be performed by a comparison component as described with reference to FIGS. 7 through 9.

At block 1425, the method may include switching from operating the STA 115 in a first chain configuration mode to operating the STA 115 in a second chain configuration mode for communication on the wireless channel based on the value of the packet rate and the value of the channel congestion. Thus, the method may include switching chain configuration modes based on a first value for a first metric and a second value for a second metric. The operations of block 1425 may be performed according to the methods described with reference to FIGS. 2 through 6. In certain examples, the operations of block 1425 may be performed by a chain configuration component as described with reference to FIGS. 7 through 9.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communications at a wireless device, comprising:
a memory that stores instructions; and
a processor coupled with the memory, wherein the processor and memory are configured to:
monitor traffic on a wireless channel;
determine a series of values for a first metric associated with the monitored traffic; and
switch from operating the apparatus in a first chain configuration mode to operating the apparatus in a second chain configuration mode to communicate on the wireless channel based at least in part on the determined series of values for the first metric.

2. The apparatus of claim 1, wherein the first metric is at least one of a signal-to-noise ratio (SNR), a received signal strength indicator (RSSI), a packet rate, a channel congestion, or a difference between RSSI across chains of the first chain configuration mode, or a combination thereof.

3. The apparatus of claim 1, wherein the processor and memory are further configured to:
calculate a first value for the first metric based at least in part on the series of values; and
compare the first value for the first metric to a first predetermined threshold, wherein the switch from operating the apparatus in the first chain configuration mode to operating the apparatus in the second chain configuration mode is based at least in part on a result of the comparison.

4. The apparatus of claim 3, wherein the processor and memory are further configured to:
calculate a second value for a second metric;
compare the second value for the second metric to a second predetermined threshold; and
switch from operating the apparatus in the second chain configuration mode to operating the apparatus in the first chain configuration mode based at least in part on the comparison of the second value for the second metric to the second predetermined threshold.

5. The apparatus of claim 3, wherein the processor and memory are configured to calculate the first value by being configured to:
determine a moving average for the first metric during a first time period based at least in part on one or more values of the series of values.

6. The apparatus of claim 1, wherein the first metric is a signal strength, and the processor and memory are configured to switch from operating the apparatus in the first chain configuration mode to operating the apparatus in the second chain configuration mode by being configured to:
identify that the signal strength is less than a predetermined threshold; and
enable at least one additional chain based at least in part on the identification.

7. The apparatus of claim 1, wherein the first metric is a signal strength, and wherein the processor and memory are configured to:
determine that a signal strength difference between chains is greater than a first predetermined threshold; and
turn off one or more of the chains operated in the first chain configuration mode with the signal strength below a second predetermined threshold based at least in part on the signal strength difference.

8. The apparatus of claim 7, wherein the processor and memory are configured to determine that the signal strength difference is greater than the first predetermined threshold by being configured to:
determine a standard deviation of signal strength across the chains operated in the first chain configuration mode is greater than the first predetermined threshold.

9. The apparatus of claim 1, wherein the first metric is a channel congestion, and wherein the processor and memory are configured to monitor traffic by being configured to:
detect energy from other wireless devices on the wireless channel.

10. The apparatus of claim 1, wherein the processor and memory are further configured to:
determine a second series of values for a second metric associated with the monitored traffic, wherein the switch from operating the apparatus in the first chain configuration mode to operating the apparatus in the second chain configuration mode is based at least in part on the determined series of values for the first metric and the determined series of values for the second metric.

11. The apparatus of claim 10, wherein the first metric is a packet rate and the second metric is a channel congestion, wherein:
the processor and memory are further configured to determine that the packet rate is less than a first predetermined threshold and the channel congestion is less than a second predetermined threshold, and the processor and memory are configured to switch from operating the apparatus in the first chain configuration mode to operating the apparatus in the second chain configuration mode based at least in part on a packet rate value and a channel congestion value; or
the processor and memory are further configured to determine that the packet rate is greater than the first predetermined threshold or the channel congestion is greater than the second predetermined threshold, and the processor and memory are configured to switch from operating the apparatus in the first chain configuration mode to operating the apparatus in the second chain configuration mode based at least in part on the determination that the packet rate is greater than the first predetermined threshold or the channel congestion is greater than the second predetermined threshold, wherein the second chain configuration mode comprises a maximum number of chains supported by the apparatus.

12. The apparatus of claim 1, wherein:
the processor and memory are configured to operate in the first chain configuration mode by being configured to:
listen for a control transmission on the wireless channel using a first chain configuration of the first chain configuration mode; and
communicate on the wireless channel, based at least in part on the control transmission, using a second chain configuration of the first chain configuration mode; and
the processor and memory are configured to operate in the second chain configuration mode by being configured to communicate on the wireless channel using a third chain configuration of the second chain configuration mode.

13. The apparatus of claim 1, wherein the processor and memory are configured to switch from operating the wireless device in the first chain configuration mode to operating the wireless device in the second chain configuration mode by being configured to:
determine to switch from operating the wireless device in the first chain configuration mode to operating the wireless device in the second chain configuration mode to communicate on the wireless channel based at least in part on the determined series of values for the first metric;
determine to operate in a spatial multiplexing power save (SMPS) mode based at least in part on the determination to switch; and
switch from operating the wireless device in the first chain configuration mode to operating the wireless device in the second chain configuration mode after determining to operate in the SMPS mode.

14. The apparatus of claim 1, wherein:
the first chain configuration mode corresponds to at least one of a single-input-single-output (SISO) mode, a multiple-input-multiple-output (MIMO) mode, single-input-multiple-output (SIMO) mode, or a multiple-input-single-output (MISO) mode;
the second chain configuration mode corresponds to at least one of a SISO mode, a MIMO mode, SIMO mode, or a MISO mode; and
the first chain configuration mode is different from the second chain configuration mode.

15. The apparatus of claim 1, wherein the wireless device is a wireless communication terminal and further comprises an antenna and a transceiver.

16. A method for wireless communications at a wireless device, comprising:
monitoring, by the wireless device, traffic on a wireless channel;
determining a series of values for a first metric associated with the monitored traffic; and
switching from operating the wireless device in a first chain configuration mode to operating the wireless device in a second chain configuration mode to communicate on the wireless channel based at least in part on the determined series of values for the first metric.

17. The method of claim 16, wherein the first metric is at least one of a signal-to-noise ratio (SNR), a received signal strength indicator (RSSI), a packet rate, a channel congestion, or a difference between RSSI across chains of the first chain configuration mode, or a combination thereof.

18. The method of claim 16, further comprising:
calculating a first value for the first metric based at least in part on the series of values; and
comparing the first value for the first metric to a first predetermined threshold, wherein switching from operating the wireless device in the first chain configuration mode to operating the wireless device in the second chain configuration mode is based at least in part on a result of the comparison.

19. The method of claim 18, further comprising:
calculating a second value for a second metric;
comparing the second value for the second metric to a second predetermined threshold; and
switching from operating the wireless device in the second chain configuration mode to operating the wireless device in the first chain configuration mode based at least in part on the comparison of the second value for the second metric to the second predetermined threshold.

20. The method of claim 18, wherein calculating the first value comprises:
determining a moving average for the first metric during a first time period based at least in part on one or more values of the series of values.

21. The method of claim 16, wherein the first metric is a signal strength, and switching from operating the wireless device in the first chain configuration mode to operating the wireless device in the second chain configuration mode comprises:
identifying that the signal strength is less than a predetermined threshold; and
enabling at least one additional chain based at least in part on the identification.

22. The method of claim 16, wherein the first metric is a signal strength, the method further comprising:
determining that a signal strength difference between chains is greater than a first predetermined threshold; and
turning off one or more of the chains operated in the first chain configuration mode with the signal strength below a second predetermined threshold based at least in part on the signal strength difference.

23. The method of claim 22, wherein determining that the signal strength difference is greater than the first predetermined threshold comprises:
determining a standard deviation of signal strength across the chains operated in the first chain configuration mode is greater that the first predetermined threshold.

24. The method of claim 16, wherein:
the first metric is a channel congestion; and
monitoring traffic comprises detecting energy from other wireless devices on the wireless channel.

25. The method of claim 16, further comprising:
determining a second series of values for a second metric associated with the monitored traffic, wherein switching from operating the wireless device in the first chain configuration mode to operating the wireless device in the second chain configuration mode is based at least in part on the determined series of values for the first metric and the determined series of values for the second metric.

26. The method of claim 25, wherein the first metric is a packet rate and the second metric is a channel congestion, the method further comprising:
determining that the packet rate is less than a first predetermined threshold and the channel congestion is less than a second predetermined threshold, wherein switching from operating the wireless device in the first chain configuration mode to operating the wireless device in the second chain configuration mode is based at least in part on a packet rate value and a channel congestion value; or
determining that the packet rate is greater than the first predetermined threshold or the channel congestion is greater than the second predetermined threshold, wherein switching from operating the wireless device in the first chain configuration mode to operating the wireless device in the second chain configuration mode is based at least in part on the determination that the packet rate is greater than the first predetermined threshold or the channel congestion is greater than the second predetermined threshold, wherein the second chain configuration mode comprises a maximum number of chains supported by the wireless device.

27. The method of claim 16, wherein:
operating in the first chain configuration mode comprises:
listening for a control transmission on the wireless channel using a first chain configuration of the first chain configuration mode; and
communicating, based at least in part on the control transmission, on the wireless channel using a second chain configuration of the first chain configuration mode; and
operating in the second chain configuration mode comprises:
communicating on the wireless channel using a third chain configuration of the second chain configuration mode.

28. The method of claim 16, wherein switching from operating the wireless device in the first chain configuration mode to operating the wireless device in the second chain configuration mode comprises:
determining to switch from operating the wireless device in the first chain configuration mode to operating the wireless device in the second chain configuration mode to communicate on the wireless channel based at least in part on the determined series of values for the first metric;
determining to operate in a spatial multiplexing power save (SMPS) mode based at least in part on the determination to switch; and
switching from operating the wireless device in the first chain configuration mode to operating the wireless device in the second chain configuration mode after determining to operate in the SMPS mode.

29. An apparatus for wireless communication at a wireless device, comprising:
means for monitoring, by the wireless device, traffic on a wireless channel;
means for determining a series of values for a first metric associated with the monitored traffic; and
means for switching from operating the wireless device in a first chain configuration mode to operating the wireless device in a second chain configuration mode to communicate on the wireless channel based at least in part on the determined series of values for the first metric.

30. A non-transitory computer readable medium storing code for wireless communication at a wireless device, the code comprising instructions executable by a processor to:
monitor, by the wireless device, traffic on a wireless channel;
determine a series of values for a first metric associated with the monitored traffic; and
switch from operating the wireless device in a first chain configuration mode to operating the wireless device in a second chain configuration mode to communicate on the wireless channel based at least in part on the determined series of values for the first metric.
